(19) United States
(12) Patent Application Publication
(10) Pub. No.: US 2026/0135818 A1
(43) Pub. Date: May 14, 2026

(54) PROTOCOL DATA UNIT (PDU) SET SIZE INDICATION CORRECTION BASED ON AN INACCURACY CONDITION

(71) Applicant: Lenovo (United States) Inc., Morrisville, NC (US)

(72) Inventor: Razvan-Andrei Stoica, Essen (DE)

(73) Assignee: Lenovo (United States) Inc., Morrisville, NC (US)

(21) Appl. No.: 18/943,631

(22) Filed: Nov. 11, 2024

(51) Int. Cl. H04L 47/36; H04L 65/65; H04W 28/02

(52) U.S. Cl. CPC H04L 47/365; H04L 65/65; H04W 28/0268

(57) ABSTRACT

Various aspects of the present disclosure relate to protocol data unit (PDU) set size indication correction based on an inaccuracy condition. An apparatus, such as a real-time protocol (RTP) receiver, receives one or more PDU sets from an RTP sender. Each PDU set of the one or more PDU sets is associated with a respective PDU set size (PSSize) and includes a respective PSSize indication. The RTP receiver transmits, to the RTP sender and in response to an inaccuracy condition being satisfied, a correction factor for PSSize indications. The correction factor is based on a comparison between the respective PSSize and the respective PSSize indication. The RTP sender uses the correction factor to calculate a corrected PSSize and a corrected PSSize indication for each PDU set of a second one or more PDU sets. The RTP sender transmits the second one or more PDU sets to the RTP receiver.

### TECHNICAL FIELD

The present disclosure relates to wireless communications, and more specifically to protocol data unit (PDU) set size indications in real-time protocol (RTP).

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

Some wireless communications systems support extended reality (XR) services, including augmented reality (AR), virtual reality (VR), and mixed reality (MR). To provide satisfactory user experiences, XR services require high bit rates and low latency. In XR media (XRM) traffic, a PDU carries a unit of information at an application level, and one or more PDUs are grouped together into a PDU set. A PDU set may be mapped to a quality of service (QoS) flow (e.g., a radio bearer) for XR traffic. PDU sets mapped to a QoS flow may be treated according to a set of QoS requirements and constraints, such as a delay budget and error rate, which are configured to ensure stringent XRM requirements are met.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

Some implementations of the method and apparatuses described herein may further include an apparatus for wireless communication to receive, from an RTP device, one or more PDU sets, where each PDU set of the one or more PDU sets has a respective PDU set size and includes a respective PDU set size indication, and transmit, to the RTP device and in response to an inaccuracy condition being satisfied, a correction factor for one or more PDU set size indications, where the correction factor is based on a comparison between the respective PDU set size and the respective PDU set size indication.

In some implementations of the method and apparatuses described herein, to transmit the correction factor, the apparatus transmits the correction factor in a real-time control protocol (RTCP) feedback message. Additionally, or alternatively, the correction factor includes a feedback control information (FCI) field, and the RTCP feedback message includes one of an RTCP transport layer-level feedback message (RTCP-RTPFB) or an RTCP payload-specific feedback message (RTCP-PSFB) packet. Additionally, or alternatively, the correction factor includes a report block field, and the RTCP feedback message includes an RTCP extended report (RTCP-XR) packet.

Additionally, or alternatively, the apparatus communicates, as part of a session description protocol (SDP) offer-answer procedure with the RTP device, a configuration for the RTCP feedback message. Additionally, or alternatively, the configuration indicates at least one of a correction factor threshold associated with the inaccuracy condition, a threshold quantity of RTCP feedback message transmissions, or a threshold time interval between consecutive RTCP feedback message transmissions. Additionally, or alternatively, the correction factor includes a floating-point numeral. Additionally, or alternatively, to determine the correction factor, the apparatus obtains, based on the comparison, a ratio of the respective PDU set sizes and the respective PDU set size indications, where the inaccuracy condition is satisfied based on the ratio satisfying a threshold. Additionally, or alternatively, the RTP device includes an RTP sender device and the apparatus includes an RTP receiver device.

Some implementations of the method and apparatuses described herein may further include an apparatus for wireless communication to transmit, to an RTP device, a first one or more PDU sets, where each PDU set of the first one or more PDU sets has a respective PDU set size and includes a respective PDU set size indication, receive, from the RTP device, a correction factor for PDU set size indications based on the first one or more PDU sets, calculate, for each PDU set of a second one or more PDU sets, a respective corrected PDU set size using the correction factor, and transmit, to the RTP device, the second one or more PDU sets, where each PDU set of the second one or more PDU sets includes a respective corrected PDU set size indication based on the respective corrected PDU set sizes.

In some implementations of the method and apparatuses described herein, the correction factor is received within an RTCP feedback message. Additionally, or alternatively, the correction factor includes an FCI field, and the RTCP feedback message includes one of an RTCP-RTPFB or an RTCP-PSFB packet. Additionally, or alternatively, the correction factor includes a report block field, and the RTCP feedback message includes an RTCP-XR packet. Additionally, or alternatively, the apparatus communicates, as part of an SDP offer-answer procedure with the RTP device, a configuration for the RTCP feedback message.

Additionally, or alternatively, the configuration indicates at least one of a correction factor threshold associated with an inaccuracy condition, a threshold quantity of RTCP feedback message transmissions, or a threshold time interval between consecutive RTCP feedback message transmissions. Additionally, or alternatively, the correction factor includes a floating-point numeral. Additionally, or alternatively, the apparatus receives a second correction factor for PDU set size indications based on the second one or more PDU sets, and calculates a second corrected PDU set size for a subsequent one or more PDU sets using the second correction factor. Additionally, or alternatively, the RTP device includes an RTP receiver device and the apparatus includes an RTP sender device.

Some implementations of the method and apparatuses described herein may further include a method performed by an apparatus, the method including: receiving, from an RTP device, one or more PDU sets, where each PDU set of the one or more PDU sets has a respective PDU set size and includes a respective PDU set size indication, determining a correction factor for PDU set size indications based on a comparison between the respective PDU set sizes and the respective PDU set size indications, and transmitting, to the RTP device, the correction factor based on an inaccuracy condition being satisfied.

Some implementations of the method and apparatuses described herein may further include a method performed by an apparatus, the method including: transmitting, to an RTP device, a first one or more PDU sets, where each PDU set of the first one or more PDU sets has a respective PDU set size and includes a respective PDU set size indication, receiving, from the RTP device, a correction factor for PDU set size indications based on the first one or more PDU sets, calculating, for each PDU set of a second one or more PDU sets, a respective corrected PDU set size using the correction factor, and transmitting, to the RTP device, the second one or more PDU sets, where each PDU set of the second one or more PDU sets includes a respective corrected PDU set size indication based on the respective corrected PDU set sizes.

### BRIEF DESCRIPTION OF THE DRAWINGS

FIG. 1 illustrates an example of a wireless communications system in accordance with aspects of the present disclosure.

FIG. 2 illustrates an example CN XRM architecture, in accordance with aspects of the present disclosure.

FIG. 3 illustrates an example 1-byte RTP header extension format, in accordance with aspects of the present disclosure.

FIG. 4 illustrates an example 2-byte RTP header extension format, in accordance with aspects of the present disclosure.

FIG. 5 illustrates an example RTC functional architecture, in accordance with aspects of the present disclosure.

FIG. 6 illustrates an example RTP and RTCP protocol stack, in accordance with aspects of the present disclosure.

FIG. 7A illustrates an example RTP packet format, in accordance with aspects of the present disclosure.

FIG. 7B illustrates an example SRTP packet format, in accordance with aspects of the present disclosure.

FIG. 8 illustrates an example WebRTC protocol stack, in accordance with aspects of the present disclosure.

FIG. 9 illustrates an example RTP/SRTP header extension format, in accordance with aspects of the present disclosure.

FIGS. 10A and 10B illustrate an example RTP session, in accordance with aspects of the present disclosure.

FIG. 11 illustrates an example RTCP-RTPFB message format, in accordance with aspects of the present disclosure.

FIG. 12 illustrates an example RTCP-PSFB message format, in accordance with aspects of the present disclosure.

FIG. 13 illustrates an example RTCP-XR report block format, in accordance with aspects of the present disclosure.

FIG. 14 illustrates an example of an apparatus in accordance with aspects of the present disclosure.

FIG. 15 illustrates an example of a processor in accordance with aspects of the present disclosure.

FIG. 16 illustrates an example of an NE in accordance with aspects of the present disclosure.

FIG. 17 illustrates a flowchart of a method performed by an RTP receiver in accordance with aspects of the present disclosure.

FIG. 18 illustrates a flowchart of a method performed by an RTP sender in accordance with aspects of the present disclosure.

### DETAILED DESCRIPTION

A wireless communications system may support wireless communications for one or more devices (e.g., UEs and NEs, among other examples) that transmit and/or receive signaling via an over-the-air interface, e.g., as part of a radio access network (RAN). The devices may be configured to support various data traffic types, services, and/or applications. In some cases, the data traffic types, services, and/or applications may be related to one or more immersive technologies, such as XR, where synchronized arrival of packets may support and deliver an immersive experience. XR traffic may include multiple types of data, such as high-resolution video and audio streams, and is characterized by relatively high bit rates and relatively low latency to maintain a seamless and immersive user experience. XR traffic may be communicated between devices according to RTP and an associated control protocol, such as real-time transport control protocol (RTCP). Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

XR traffic packets (e.g., RTP packets, SRTP packets) created at an application layer of a device may travel a network path from a source to a destination across different network devices and layers, which may be referred to as cross-layer transport. Cross-layer improvements enable collaboration between layers of a protocol stack, which may support seamless connectivity across multiple network technologies, improve throughput and reliability, and reduce latency. For example, to provide cross-layer improvements of XR traffic transport over cellular networks, XR traffic packets may be encapsulated into one or more PDU sets. A PDU set may be defined as one or more PDUs carrying a payload of one unit of information generated at an application level (e.g., a frame or video slice for XRM services). A device or application transmitting PDU sets may be referred to as an RTP sender, and a device or application receiving PDU sets may be referred to as an RTP receiver. After generating PDUs, an application may “mark” the PDUs with PDU set information, which may be used by core and access networks for improved content delivery and for fulfilling QoS thresholds (e.g., latency and reliability guarantees, associated with a PDU set delay budget (PSDB) and PDU set error rate (PSER), respectively). For each PDU set, the PDU set information may include indications of PDU set boundaries (start and end), sequencing, and importance, as well as a PDU set size (PSSize). The application may derive the PSSize based on a size of the payload to be encapsulated and based on accounting for potential transport layer (i.e., IP/UDP) encapsulation overheads, respectively.

In some scenarios, however, the PSSize marked by the application may be inaccurate based on a path taken by the PDU set between the RTP sender and the RTP receiver, such that the PSSize of the PDU set received at the RTP receiver (referred to herein as an actual PSSize) is different from the PSSize indicated in the PDU set information of the PDU set (referred to herein as an indicated PSSize). For example, Internet Protocol (IP) encapsulation of the PDU set may be altered due to transport-layer transformations such as routing (e.g., segment routing), address translation, and/or IP-level segmentation on the path between the RTP sender and the RTP receiver. Incorrectly indicating PSSizes can introduce complexity and latency in processing of PDU sets and may cause inappropriate resource allocation (e.g., at a RAN level), thereby degrading radio performance and negatively impacting user experience. Additionally, conventional approaches to management of incorrect PSSize indications may rely on a feedback mechanism implemented by renegotiating a session description protocol (SDP) offer-answer procedure, which increases signaling overhead and requires service interruption to reestablish an RTP session with a new configuration.

The techniques described herein enable detection and correction of inaccurate PSSize indications without introducing significant latency or complexity. Aspects of the present disclosure define and implement a feedback control loop using real-time control protocol (RTCP) feedback messages to perform RTP sender PSSize compensation, e.g., based on RTP receiver-observed PSSizes. In an implementation, the feedback control loop carries signaling originating at a peer RTP receiver. The peer RTP receiver monitors, for each PDU set received from an RTP sender, an actual received PSSize and an indicated PSSize. The peer RTP receiver detects a variation of the received size with respect to a threshold relative to the indicated PSSize. When the threshold is met or exceeded, the RTP receiver may indicate, to the RTP sender, a correction factor for PSSize indication. For instance, the RTP receiver may indicate the correction factor as part of one or more RTCP feedback messages associated with the RTP streams marked (e.g., by the RTP sender) with a corresponding PDU set information RTP header. The RTCP feedback message(s) can be configured (e.g., once) during an initial RTP session establishment (e.g., during a one-time SDP offer/answer stage). Subsequent to reception of an RTCP feedback message including a correction factor for PSSize indication, the RTP sender may apply the correction factor when deriving PSSize indications for PDU sets to be transmitted to the RTP receiver. The RTP sender may include or be an example of a first peer UE or an RTC application server (AS), and the RTP receiver may include or be an example of a second peer UE or an RTP AS.

Aspects of the present disclosure reduce or prevent inefficient resource allocation and degraded QoS for XR services. By performing the described techniques, devices in a wireless communications system can support XR services by meeting associated QoS requirements and ensuring appropriate resource provisioning. For example, by monitoring variations in PSSize indications relative to actual PSSizes, an RTP receiver is enabled to detect inaccurate PSSize indications and convey a correction factor to an RTP sender. The RTP sender can apply the correction factor to subsequent PDU set transmissions to improve accuracy of PSSize indications, thereby avoiding increased latency and complexity. Additionally, improving PSSize indication accuracy may prevent overallocation or under-allocation of resources impacting QoS flow performance and scheduling.

Aspects of the present disclosure are described in the context of a wireless communications system.

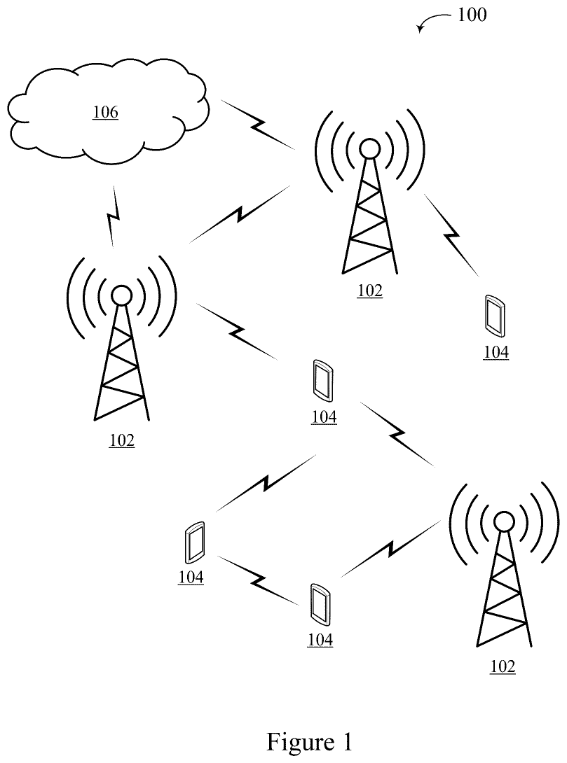

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a RAN, a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a PDU session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHZ), FR3 (7.125 GHZ-24.25 GHz), FR4 (52.6 GHz-114.25 GHZ), FR4a or FR4-1 (52.6 GHz-71 GHZ), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing

Devices in the wireless communications system 100, such as UEs 104 and NEs 102, may support XR traffic. XR is referred to hereafter as an umbrella term for different types of realities, including VR, AR, and MR. VR is a rendered version of a delivered visual and audio scene. The rendering may be designed to mimic visual and audio sensory stimuli of the real world as naturally as possible to an observer or user as they move within the limits defined by the application. In some scenarios, a user may wear a head mounted display (HMD), to completely replace the user's field of view with a simulated visual component, and/or headphones, to provide the user with accompanying audio. Some form of head and motion tracking of the user in VR may be implemented to allow the simulated visual and audio components to be updated in real time, which may ensure that, from the user's perspective, items and sound sources in the rendering remain consistent with the user's movements. In some examples, additional means to interact with a VR simulation may be provided.

In AR, a user is provided with additional information, artificially generated items, and/or content overlaid upon the user's current environment. Such additional information or content may be visual and/or audible and the user's observation of their current environment may be direct, e.g., with no intermediate sensing, processing, and rendering. Alternatively, the user's observation of their current environment may be indirect, such that the user's perception of their environment is relayed via sensors and, in some cases, may be enhanced or processed. MR may be understood as an advanced form of AR in which some virtual elements are inserted into a physical scene with the intent to provide an illusion that the virtual elements are part of the physical scene.

XR refers to all real-and-virtual combined environments and human-machine interactions generated by computer technology and wearables. It includes representative forms such as AR, MR, and VR and areas interpolated among them. The levels of virtuality range from partially sensory inputs to fully immersive VR. A key aspect of XR is the extension of human experiences especially relating to the senses of existence (represented by VR) and the acquisition of cognition (represented by AR).

Traffic for immersive and interactive XR applications as described herein requires often real-time suited transport architectures and protocols. As part of the latter, the state of art is represented by RTP, its securely provisioned Secure Real-time Transport Protocol (SRTP), and its web-targeted stack Web Real-Time Communications WebRTC, respectively. RTP is a media codec agnostic network protocol with application-layer framing used to deliver multimedia (e.g., audio, video etc.) data in real-time over IP networks. It is used in conjunction with a sister protocol for control, RTCP, to provide end-to-end features such as jitter compensation, packet loss and out-of-order delivery detection, synchronization, and source streams multiplexing.

3GPP Release 18 includes an XRM feature at a CN level and introduces the concept of a PDU set to handle QoS requirements of XRM applications and streams, e.g., with improved granularity compared to 5G Release 17 QoS flow possibilities. A PDU set may be defined as one or more PDUs carrying a payload of one unit of information generated at an application level. For example, an application layer of a device (e.g., an RTP sender, such as a UE 104 or an AS) may generate audio or video data and convey the data to a transport layer of the device. At the transport layer, the device adds an RTP header that includes PDU set information and, in some cases, user datagram protocol (UDP) header information, to form a UDP PDU that includes both the RTP header and the application data (referred to as an RTP payload). Additional information and/or headers may be added prior to transmission of the PDU. Multiple PDUs may be grouped together to form a PDU set. At a receiving device (e.g., an RTP receiver, such as a UE 104), in some examples, an application layer must obtain all PDUs in a PDU set to use the corresponding unit of information. In other examples, the application layer may be capable of recovering all or a portion of the information unit, such as when some PDUs of a PDU set are missing or are otherwise not successfully received. In some cases, PDU sets may be communicated using SRTP in a same manner as RTP.

3GPP Release 17 analyzed XR traffic models and concluded QoS requirements in terms of delay budget, data rate, and error rate necessary for a satisfactory experience at the application level. Additional 5G QoS identifiers (5QIs) are thus defined for 5G system (5GS) XR QoS flows, applicable to XR video streams and for controlling metadata necessary to provide immersive and interactive XR experiences. PSDBs and other QoS parameters can be specifically configured for XR traffic. QoS flow management involves setting up QoS flows with configured parameters such as a guaranteed bit rate (GBR) and a maximum bit rate (MBR). XR traffic is then assigned to a QoS flow configured with high priority, low latency, and high reliability settings. To enable PDU set-based QoS handling for XR traffic, PDU set QoS parameters are provided by a session management function (SMF) of a network to an NE 102, e.g., as part of a QoS profile of a QoS flow. These PDU set QoS parameters may include a PSDB, a PSER, and/or PDU set integrated handling information (PSIHI), among other examples. The PDU set QoS parameters are common for (e.g., shared among) all PDU sets mapped to a QoS flow.

The PSDB defines an upper bound for a time duration that a PDU set may be delayed between a UE 104 and an N6 termination point at a user plane function (UPF). The PSDB applies to downlink PDU sets received by the UPF over the N6 interface and to uplink PDU sets transmitted by a UE 104. The PSER defines an upper bound for a rate of PDU sets that have been processed by a sender of a link layer protocol (e.g., a radio link control (RLC) layer) when all PDUs in a PDU sets are not successfully delivered, by a corresponding receiver, to an upper layer (e.g., a packet data convergence protocol (PDCP) layer).

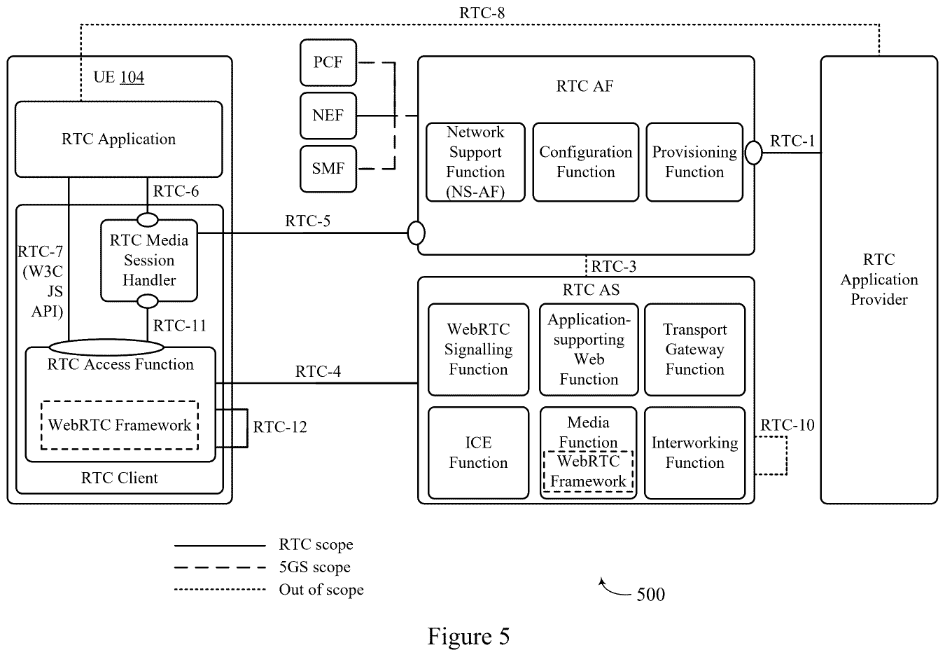

3GPP specified a general media delivery architecture in Release 18, unifying concepts from both 5G Media Streaming (MS) (as specified in TS 26.501 as incorporated herein) and Real-Time Communications (RTC) (as specified in TS 26.506 as incorporated herein) subsystems under a generic media delivery architecture introduced in TS 26.501. The 5G RTC realization of the generic media delivery architecture aims at enabling media delivery services for RTC such as XR, AR conversational, mobile cloud gaming, and the like. The media delivery is set up and exchanged between two or more RTC endpoints over 5GS and is based on the WebRTC framework included in the RTC endpoints. Examples of RTC endpoints include UEs 104 and/or RTC AS, for example, deployed as an edge computing server or within an ASP data network domain. The ASP provides an RTC application on the UE 104 to make use of the RTC endpoint and network functions using interfaces and APIs as defined in TS 26.506 and illustrated in FIG. 5, which instantiates the generic media delivery architecture over 5GS for RTC services.

XR video traffic primarily includes multiple DL/UL video streams of relatively high resolution (e.g., at least 1080p dual-eye buffer), frames-per-second (fps) (e.g., 60+fps), and high bandwidth (e.g., usually at least 20-30 Mbps). The video streams are to be transmitted across a network with minimal delay (typically upper bounded by 15-20 ms) to maintain a reduced end-to-end application round-trip interaction delay. Such requirements are of critical importance given XR application dependency on cloud/edge processing (e.g., content downloading, viewport generation and configuration, viewport update, viewport rendering, media encoding/transcoding, etc.). Additionally, XR traffic may include one or more audio streams, as well as user interaction metadata (e.g., user actions, user inputs, user pose), or alternatively, feedback and control metadata (e.g., actions, XR space metadata, transport control and feedback messages over RTCP, etc.).

XR traffic packets (e.g., RTP packets, SRTP packets) created at an application layer may undergo encapsulation and transformation as they travel a network path from a source (e.g., an RTP sender, such as an AS or a UE 104) to a destination (e.g., an RTP receiver, such as a UE 104) across different network devices and layers. These packets may be communicated as PDU sets, which may be marked with PDU set information at the RTP sender. The RTP sender may derive a PSSize for a PDU set based on IP/UDP/RTP header encapsulation, such that the PSSize accounts for an IP header, a UDP header, and an RTP header. The PSSize may represent the PSSize seen by the RTP sender before the PDU set is transmitted over the network. In some examples, the PSSize may be defined and indicated in bytes.

Transformations may alter transport-level encapsulation as packets are adapted to requirements of each traversed network, such as changes made to packet headers. Such transformations may occur as a result of encapsulation, decapsulation, routing and IP address changes, network protocols, fragmentation and reassembly, QoS marking, and other modifications. Transformations may change a size of a PDU set and may therefore affect an indicated PSSize with which the PDU set is marked in an RTP header extension. For example, the indicated PSSize is calculated at the PDU set source (e.g., the RTP sender) by including the RTP, UDP, and IP packet headers, and is indicated in the RTP header extension for PDU set marking. However, a PSSize seen by the UPF (e.g., an actual PSSize of the PDU set received at the UPF) may be different from the indicated PSSize as a result of transformations incurred by the PDU set over the network path between the RTP sender and the UPF.

In some examples, transformations may be due to lack of joint IP version 4 (IPv4) and IP version 6 (IPv6) support in the CN 106, network address translation (NAT) 46 (NAT46) and NAT64 translations, and/or Traversal Using Relays around NAT (TURN) relaying for NAT traversal. For instance, a joint IPv4/IPv6 network may use NAT64 or NAT46 techniques to translate between IPv4 and IPV6 addresses. NAT64 may allow IPV6 devices to access IPv4 resources by translating IPv6 addresses into IPv4, while NAT46 does the reverse. NAT46/NAT64 translations may allow IPv4-only devices to communicate with IPV6-only devices and vice versa. TURN is a protocol that assists in NAT traversal for applications that require real-time, peer-to-peer connections, such as XRM, video calls, voice over IP (VOIP), and online gaming. In NAT traversal, a NAT device may hide internal IP addresses of devices on a local network, making it difficult for external peers to directly connect to these devices. Thus, TURN may be implemented when direct peer-to-peer connections are not possible due to restrictive NAT types or firewalls that block incoming connections, where a TURN server may act as a relay device for two devices that are unable to directly connect with one another.

If the CN 106 does not support both IPV4 and IPV6, for instance, NAT64/NAT46 translation may change the actual PSSize of the PDU set. Additionally, or alternatively, IP fragmentation may occur when the RTP sender fails to appropriately discover a maximum transmission unit (MTU) for the network path or fails to set an adequate RTP payload size, whereby each increment in the number of IP packets increases the actual PSSize by an amount equivalent to an IP packet header. As another example, in TURN relaying, a TURN server may add a Session Traversal Utilities for NAT (STUN) message header, a STUN attribute, and a transport address to the PDU set, increasing the actual PSSize. When the actual PSSize differs from the indicated PSSize, PDU set information associated with the PDU set may be affected, particularly within the CN 106 and RAN. As a result, communication resources may be over-allocated or under-allocated, impacting QoS flow performance and resource scheduling.

In some examples, signaling a correction factor for an incorrect PSSize via an SDP offer-answer procedure between the RTP sender and an RTP receiver is possible, but requires renegotiation (e.g., re-invite via session initiation protocol (SIP)) of the active RTP session. This may, in practice, lead to service interruption during RTP session reconfiguration, which negatively impacts performance and user experience in immersive and interactive real-time communications services such as XRM. Additionally, or alternatively, the UPF may be able to correct for on-path transformations that may affect accuracy of the indicated PSSize based on deep traffic inspection and buffering of multiple (or all) PDUs of each PDU set in transit. However, this method is very complex and may introduce significant latency at the UPF in routing PDUs and PDU sets to their corresponding QoS flows. Further, this may impact other services and/or users besides XRM services, given the complexity and potential high operation loads at the UPF. It is therefore beneficial and desirable that the PSSize originating at the RTP sender is close to the one seen by the RTP receiver (over the RAN air-interface) to reduce the UPF complexity and/or additional latency that may be incurred on the path due to UPF processing of PDUs of a PDU Set or inappropriate resource allocation at the RAN due to inaccurate PDU Set size.

Accordingly, aspects of the present disclosure enable an indicated PSSize of a PDU set originating at the RTP sender to be relatively close to an actual PSSize of the PDU set received at the RTP receiver. The described techniques may reduce UPF complexity and/or additional latency incurred on the network path due to UPF processing or inappropriate resource allocation at the RAN due to inaccurate PSSize indications. As described herein, the RTP sender and the RTP receiver may implement a control feedback loop using RTCP feedback messages. The control feedback loop may assist the RTP sender to correct indicated PSSizes based on actual PSSizes of PDU sets received at the RTP receiver (e.g., at an IP level).

The RTP sender may calculate a respective PSSize for each PDU set of one or more PDU sets to be transmitted to the RTP receiver. The RTP sender may mark each PDU set with the respective calculated PSSize, for example, by including a PSSize indication corresponding to the calculated PSSize in an RTP header of the PDU set. The RTP sender may transmit, and the RTP receiver may receive, the one or more PDU sets. The RTP receiver may determine, for each PDU set, an actual PSSize of the PDU set upon reception at the RTP receiver and an indicated PSSize included in the RTP header. The RTP receiver may compare the actual PSSize and the indicated PSSize. If the actual PSSize and the indicated PSSize are different, the RTP receiver may determine that the indicated PSSize is incorrect. Based on the comparison, the RTP receiver may determine if the PSSize inaccuracy meets an inaccuracy condition for reporting a correction factor. The inaccuracy condition may be, for example, a relative variation threshold between the actual PSSizes and the indicated PSSizes. For instance, the threshold may have a value of 1.05 for a 5% under-provisioning due to indicated PSSizes being less than actual PSSizes.

By observing and comparing PSSize indications and corresponding actual PSSizes, the RTP receiver can determine a correction factor (e.g., a ratio of the actual PSSize to the indicated PSSize). When the RTP receiver determines that the inaccuracy condition is met or otherwise satisfied, the RTP receiver calculates and indicates, as part of an RTCP feedback message, a correction factor for PSSize indications. The RTP sender may apply the correction factor to subsequent calculations of PSSize indications to correct for on-path transformations that may affect PSSize accuracy. For example, the RTP sender may multiply a derived PSSize by the correction factor to obtain a corrected PSSize and may mark the PDU set with the corrected PSSize.

The control feedback loop is designed on top of RTCP feedback messages from the RTP receiver in the user plane. The RTCP feedback messages may be event-driven (e.g., if variation observed by the RTP receiver exceeds a detection threshold), associated with a low bandwidth, and enable accurate correction of indicated PSSizes at the RTP sender. In implementations, the RTP sender and the RTP receiver may communicate, as part of an SDP offer-answer procedure, a configuration for the RTCP feedback messages. The configuration may indicate a correction factor threshold associated with the inaccuracy condition, a threshold quantity of RTCP feedback message transmissions, a threshold time interval between consecutive RTCP feedback message transmissions, or some combination thereof.

The correction factor may be signaled according to one of three RTCP signaling approaches for the RTCP feedback messages, each approach extending an existing Internet Engineering Task Force (IETF) RTCP feedback framework. A first and second signaling approach each extend an audio-video extended RTCP profile by means of a new RTCP feedback message, the first signaling approach using transport-level RTCP feedback and the second signaling approach using payload-specific RTCP feedback (e.g., only for an RTP stream marked with PDU set marking). In these two approaches, the correction factor may be indicated within a feedback control information (FCI) field.

A third approach extends the RTCP Extended Report (RTCP-XR) framework in Request for Comments (RFC) 3611 to include a block report for the correction factor. In this approach, the correction factor may be indicated in a report block field. In all signaling approaches, the correction factor is encoded as a floating point 32 (FP32) 32-bit field. Additionally, in all signaling approaches, the extended signaling messages need to be standardized in 3GPP and later registered with the Internet Assigned Numbers Authority (IANA) to be interoperable.

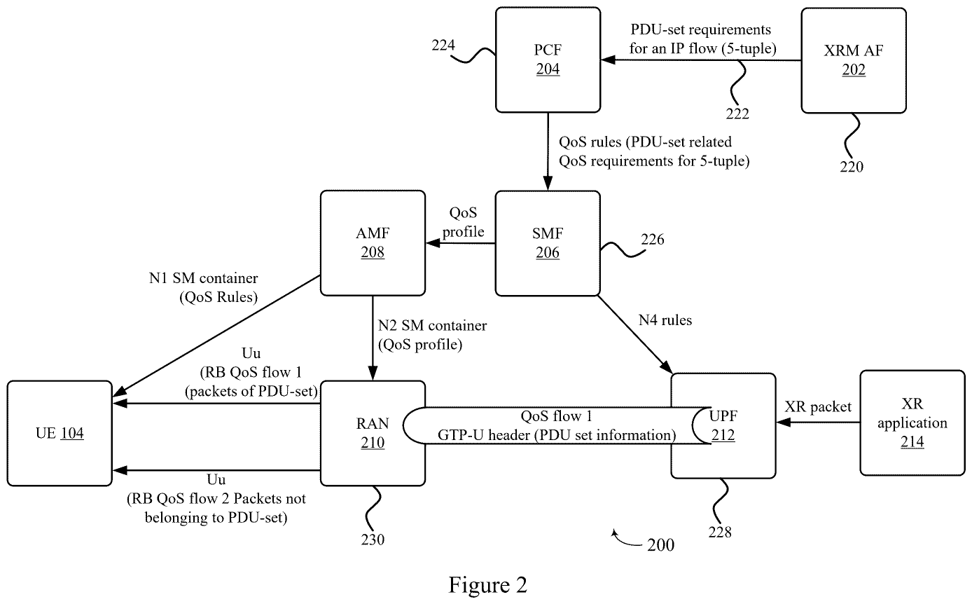

FIG. 2 illustrates an example CN XRM architecture 200 in accordance with aspects of the present disclosure. The CN XRM architecture 200 includes an XRM Application Function (XRM AF) 202, a Policy and Control Function (PCF) 204, a Session Management Function (SMF) 206, an Access and Mobility Function (AMF) 208, a RAN 210, a UE 104, a UPF 212, and an XR application 214. The CN XRM architecture 200 may implement or be implemented by aspects of the wireless communications system 100. For example, the UE 104 and the UPF 212 may include or be an example of a UE 104 and an NE 102, respectively, as described with reference to FIG. 1. The following description relates to operation of the CN XRM architecture 200 in an example of downlink traffic. The CN XRM architecture 200 may implement a similar process for uplink traffic.

At 220, the XRM AF 202 determines PDU set requirements for an IP flow. At 222, the XRM AF 202 provides QoS requirements for packets of a PDU set to the PCF 204 and information to identify the XR application 214, such as a 5-tuple or application identifier (ID). The QoS requirements may include PSDB and PSER. The XRM AF 202 may also include an importance parameter for a PDU set and information for identifying packets belonging to a PDU set.

At 224, the PCF 204 derives QoS rules for the XR application 214 and specific QoS requirements for the PDU set, and configures the SMF 206. The QoS rules may include or be an example of PDU set-related QoS requirements for the 5-tuple and may utilize a 5G QoS identifier (5QI) for XRM traffic. The PCF 204 sends the QoS rules to the SMF 206. The PCF 204 may indicate, to the SMF 206, PCC rules per importance of a PDU set. The PCC rules may be derived according to information received from the XRM AF 202 or based on an operator configuration.

At 226, the SMF 206 establishes a QoS flow according to the QoS rules by the PCF 204 and configures the UPF 212 to route packets of the XR application 214 to a QoS flow, and, in addition, to enable PDU set handling. The SMF 206 also provides a QoS profile containing the PDU set QoS requirements to the RAN 210 via the AMF 208. The AMF 208 may provide the QoS profile containing the PDU set QoS requirements to the RAN 210 in an N2 SM container. Further, the AMF 208 may provide the QoS rules to the UE 104 in an N1 SM container.

At 228, the UPF 212 inspects the packets and determines packets belonging to a PDU set. For example, the UPF 212 may inspect RTP packet headers according to implementation or based on AS-marked PDU set information transmitted via RTP PDU set header extensions, e.g., as determined based on SDP offer/answer negotiation of an RTP header extension urn: 3gpp:pdu-set-marking:rel-18. When the UPF 212 detects packets of a PDU set, the UPF 212 marks the packets belonging to a PDU set within a GTP-U header. The GTP-U header information includes a PDU set sequence number and a size of the PDU set (e.g., PSSize). The UPF 212 may also determine the importance of the PDU set according to UPF 212 implementation, information provided by the XRM AF 202, or information provided as metadata from an XRM application server. Based on the importance of the PDU set, the UPF 212 may route the traffic to a corresponding QoS flow 1 (e.g., according to the QoS rules received from the SMF 206) or may include (e.g., mark) the importance of the PDU set within a GTP-U header. In some examples, the QoS flow 1 may comprise GTP-U headers, which may include PDU set information.

At 230, the RAN 210 identifies packets belonging to a PDU set (e.g., based on the GTP-U marking) and handles the packets of the PDU set according to the QoS requirements of the PDU set as provided by the SMF 206. In some examples, the RAN 210 may use a different radio bearer with a higher QoS requirement (e.g., according to the PDU set PSDB and PSER) to guarantee delivery of the packets of the PDU set, while using a different radio bearer according to the 5QI of the QoS flow for the non-PDU-set packets.

The RAN 210 may receive QFIs, QoS profile of QoS flow from SMF 206 (via AMF 208) during PDU session establishment/modification which includes PDSB and PSER. RAN 210 inspects GTP-U headers and ensures all packets of the same PDU set are handled according to the QoS profile. This may include packets of PDU-set in a radio bearer carrying QoS flow 1. This may also include sending packets not belonging to the PDU-set in a different radio bearer carrying QoS flow 2.

The example illustrated in FIG. 2 relates to downlink traffic. Reciprocal processing is applicable to uplink traffic, where the role of UPF 212 packet inspection is taken by the UE 104. The UE 104 is expected to mark packets at an application level, inspect uplink packets (e.g., at ingress of Layer 2), determine packets belonging to a PDU set, and signal (e.g., via buffer status reports (BSRs) and/or delay status reports (DSRs)) the PDU set to the RAN 210 for scheduling and resource allocation, e.g., corresponding to an associated DRB capable of fulfilling the PDU set QoS requirements (e.g., PSDB and PSER). The low-level signaling mechanism associated with uplink UE-to-RAN information passing are up to specification and implementations of RAN signaling procedures.

XRM Release 18 enabled PDU set QoS integrated handling, in which a PDU Session Anchor UPF (PSA UPF) identifies PDUs that belong to PDU sets and determines, for each PDU set, associated PDU set information sent via NG-RAN in a GTP-U header. The PDU set information comprises a PDU set sequence number, an indication of an end PDU of the PDU set, a PDU sequence number within the PDU set, a PDU set size (PSSize) in bytes, and a PDU set importance. The PDU set importance identifies the relative importance of a PDU set compared to other PDU sets within a same QoS flow. In implementations, this PDU set information may be used by the RAN 210 and the CN XRM architecture 200 as illustrated in FIG. 2 for PDU set-based QoS handling as described herein. For example, the UPF 212 may include or be an example of a PSA UPF.

In some examples, the RAN 210 may implement PDU set level packet discarding in the presence of congestion. In such examples, the RAN 210 may utilize priority levels across QoS flows and PDU set importance within a QoS flow to determine packets to discard. Additionally, or alternatively, the PSA UPF may identify PDUs that belong to PDU sets and if the PSA UPF receives a PDU that does not belong to a PDU set (e.g., based on a protocol description for PDU set identification), such as a PDU that has not been marked with PDU set information by the AS, then the PSA UPF may still map the PDU to a PDU set and determine the PDU set information as described above. This ensures that, for a QoS flow with PDU sets enabled, all PDUs belong to a PDU set. To this end, if the PSA UPF receives a PDU that does not belong to a PDU set, it is assumed that the PSA UPF determines the PDU set importance value based on pre-configuration or a default importance signaled by an AS and/or AF.

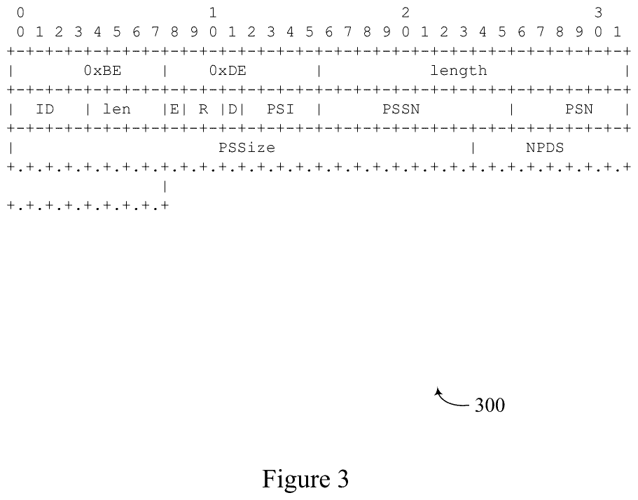

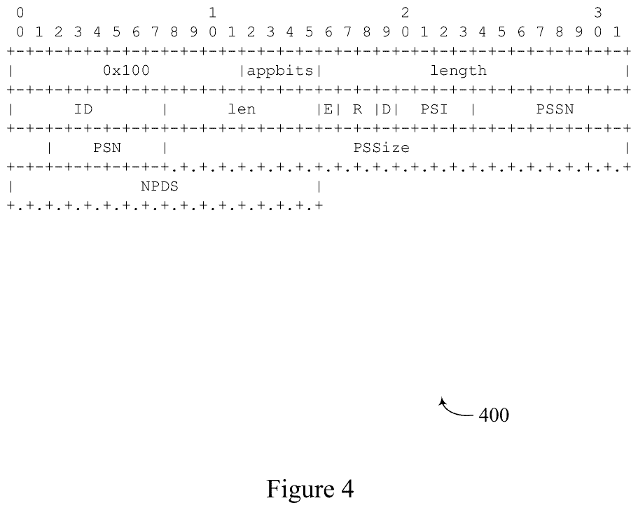

FIGS. 3 and 4 illustrate an example 1-byte RTP header extension format 300 and an example 2-byte RTP header extension format 400, respectively, in accordance with aspects of the present disclosure. The 1-byte RTP header extension format 300 and/or the 2-byte RTP header extension format 400 may implement or be implemented by aspects of the wireless communications system 100 and the CN XRM architecture 200 as described herein. For example, the 1-byte RTP header extension format 300 and/or the 2-byte RTP header extension format 400 may be utilized by an RTP sender (e.g., a UE 104, an AS) to mark PDU sets and to indicate PDU set information as described with reference to FIGS. 1 and 2.

The semantics of the fields denoted in the 1-byte RTP header extension format 300 and/the 2-byte RTP header extension format 400 are as follows:

E is a 1-bit field that marks an end PDU of the PDU set. E is a flag that may be set to a value of 1 for a last PDU of the PDU set and set to a value of 0 for all other PDUs of the PDU set.

EDB is an End of Data Burst field that can include up to 3 bits and indicates the end of a data burst. The field is set to a non-zero value when the end of data burst is present and is set to zero otherwise.

PSI is a 4 bit field that indicates PDU set importance compared to other PDU sets within a same QoS flow. Lower values indicate a higher importance PDU set. For example, a highest importance PDU set may be associated with a value of 0 and a lowest importance PDU set may be associated with a value of 15.

PDU set sequence number (PSSN) is a 10 bit field that encodes a sequence number of the PDU set to which the current PDU belongs. PSSN may act as a 10-bit numerical identifier for the PDU set and wraps around at 1023.

PSN indicates a PDU sequence number within a PDU set. PSN is a 6 bit field that indicates the sequence number of the current PDU within the PDU set. The PSN is set to 0 for the first PDU in the PDU set and incremented monotonically for every PDU in the PDU set in order of transmission from the sender. PSN wraps around at 63.

PSSize is a 24 bit field that indicates a total (e.g., aggregate) size of all PDUs of the PDU set to which the PDU belongs. This field is optional and subject to an SDP signaling offer/answer negotiation, where an RTP sender (e.g., a UE or AS) may indicate whether the RTP sender will be able to provide the size of the PDU set for that RTP stream. If not enabled, the field is not present. If enabled, but the RTP sender is not able to determine the PSSize for a particular PDU set, the RTP sender may set the value to 0 in all PDUs of that PDU set. The PSSize indicates the size of the PDU set including an RTP/UDP/IP header encapsulation overhead of the PDU set's corresponding PDUs. The PSSize is expressed in bytes.

NPDS is a 16 bit field that indicates a total number of PDUs belonging to a same PDU set. This field is optional and subject to an SDP signaling offer/answer negotiation, where the RTP sender may indicate whether the RTP sender will provide the number of PDUs within the PDU set for that RTP stream. If enabled, but the RTP sender is not able to determine the number of PDUs in the PDU set, it shall set the value to 0 in all PDUs of that PDU set. It is recommended to add the NPDS field when the PSSize field is present.

FIG. 5 illustrates an example RTC functional architecture 500 in accordance with aspects of the present disclosure. The RTC functional architecture 500 may implement or be implemented by aspects of the wireless communications system 100 and/or the CN XRM architecture 200 as described herein. For example, the RTC functional architecture 500 includes a UE 104 and represents a general media delivery architecture over 5GS for RTC services as specified in 3GPP Release 18. The RTC functional architecture 500 enables media delivery services for RTC, such as XR, AR, mobile cloud gaming, and the like.

In the RTC functional architecture 500, media delivery is based on a WebRTC framework and is set up and exchanged between two or more RTC endpoints. RTC endpoints may include or be an example of UEs, such as the UE 104, AS, or the like, which may be deployed as an edge computing server or within an active server page (ASP) data network domain. The ASP may provide an RTC application on the UE 104 to utilize the RTC endpoint and network functions, e.g., using interfaces and APIs as defined in TS 26.506 and illustrated in FIG. 5.

With reference to FIG. 5, solid lines illustrate reference points and interfaces that are part of the 5G RTC subsystem, dashed lines illustrate components that are in scope of 5GS (e.g., as specified in general 5GS architecture of TS 23.501), and dotted lines illustrate components that are in scope of the ASP and may be customized to match the requirements of various services and/or applications deployed over 5G RTC architecture.

As illustrated, the RTC functional architecture 500 includes the following RTC functional blocks:

RTC AF: An AF dedicated to RTC media delivery.

RTC AS: An AS dedicated to RTC media delivery.

RTC Client: A UE media client internal function dedicated to RTC media delivery comprising an RTC media session handler and an RTC access function.

RTC media session handler: An entity of the UE 104 that communicates with the RTC AF to configure, control and support delivery of an RTC media session.

RTC access function: An entity on the UE 104 that communicates with an RTC AS, or another RTC access function in a peer UE 104, to access and deliver media content. The media access function, for example, may be further subdivided into content delivery protocols, codecs, media types, and metadata representation.

WebRTC framework: A well-defined subset of the WebRTC protocol stack for data transport and data framing that supports real-time media communication between an RTC endpoint and its peer(s) within the scope of an RTC session.

The RTC functional architecture 500 includes the following reference points:

RTC-1: Reference point between the RTC application provider and the RTC AF for the provisioning of media delivery sessions.

RTC-3: Reference point between the RTC AF and the RTC AS for purposes of RTC AS configuration and/or media session handling (e.g., QoS/QoE reporting, and/or reconfiguration) in relation to media delivery.

RTC-4: Reference point used to exchange the WebRTC media traffic (e.g., (S) RTP, RTCP, data channel application data, or other application data) between the RTC access function and the media function of the RTC AS, as well as to exchange signaling information (e.g., SDP offer-answer procedure) relating to the WebRTC session with the RTC AS such as WebRTC signaling function.

RTC-5: Reference point RTC-5 used to convey configuration information from the RTC AF to the RTC media session handler and used by the RTC media session handler to request media session handling support from the RTC AF for RTC sessions (e.g., media configurations recommendations, ICE negotiation and configuration of STUN/TURN servers location, QoS allocation, QoE metrics reporting configuration, QoE/media consumption metrics reporting, etc.).

RTC-6: Reference point used as client API exposing RTC media session handler functionality to RTC application.

RTC-7: Reference point used as client interface to provide the capabilities of RTC access function as API to RTC application (e.g., Native WebRTC App, W3C-defined JavaScript APIs for WebRTC etc.).

RTC-8: Proprietary reference point between the RTC application and the RTC application Provider, which may be used to exchange configuration information related to the RTC session or the application.

RTC-10: Reference point between one instance of the media AS and another for the purpose of distributed service chaining over multiple RTC AS instances (e.g., using different functions hosted by different RTC AS instances).

RTC-11: Reference point used by the RTC access function to configure media session handling in the RTC media session handler and/or used by the RTC media session handler to configure media access in the RTC access function. This reference point may be internal only to implementation and may not be exposed as API externally to RTC application developers.

RTC-12: Reference point used for peer-to-peer media delivery over WebRTC traffic between RTC access functions in different UEs 104 when the 5GS permits peer-to-peer media transport. The protocols supported at this reference point shall be a subset of those RTC-4 for media delivery, e.g., WebRTC.

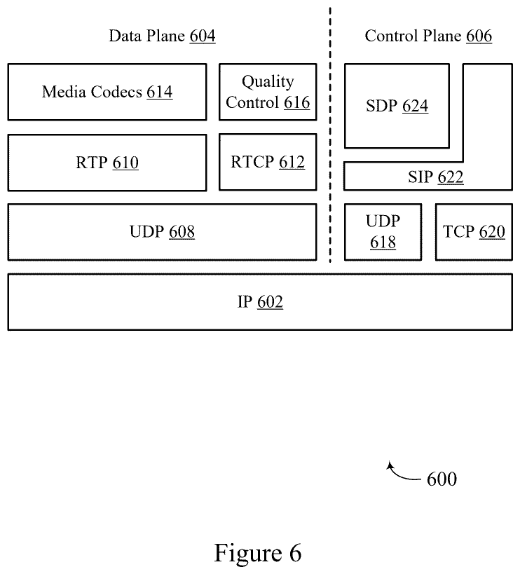

FIG. 6 illustrates an example RTP and RTCP protocol stack 600 in accordance with aspects of the present disclosure. An RTP sender and an RTP receiver may communicate XR traffic (e.g., RTP packets, SRTP packets) as PDU sets as described herein according to the RTP and RTCP protocol stack 600.

In the example of FIG. 6, an IP layer 602 carries signaling from a data plane 604 and a control plane 606. The data plane 604 stack includes functions for a UDP 608, RTP 610, RTCP 612, media codecs 614, and quality control 616. The control plane 606 stack includes functions for UDP 618, a Transmission Control Protocol (TCP) 620, SIP 622, and SDP 624.

Traffic for immersive and interactive XR applications as described herein rely on real-time transport architectures and protocols, such as the RTP and RTCP protocol stack 600. The RTP 610 is a media codec agnostic network protocol with application-layer framing used to deliver multimedia (e.g., audio, video etc.) data in real-time over IP networks. It is used in conjunction with a sister protocol for control, the RTCP 612, to provide end-to-end features such as jitter compensation, packet loss and out-of-order delivery detection, synchronization, and source streams multiplexing.

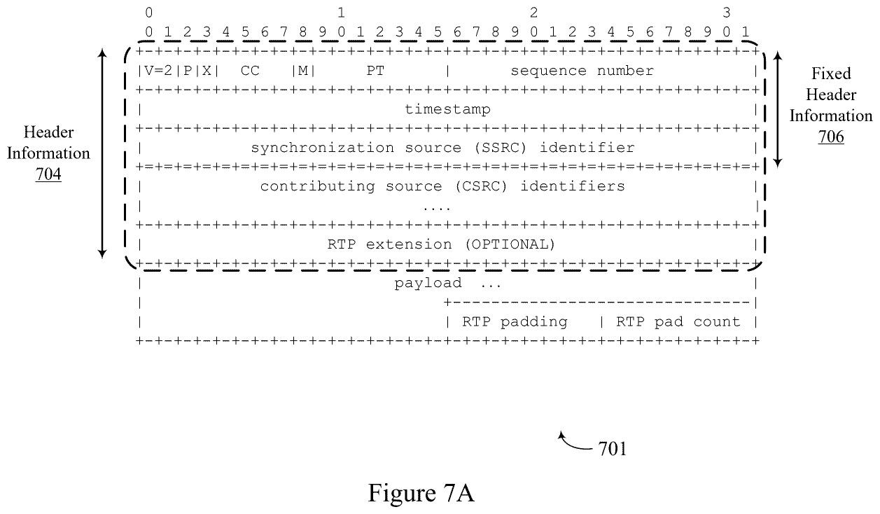

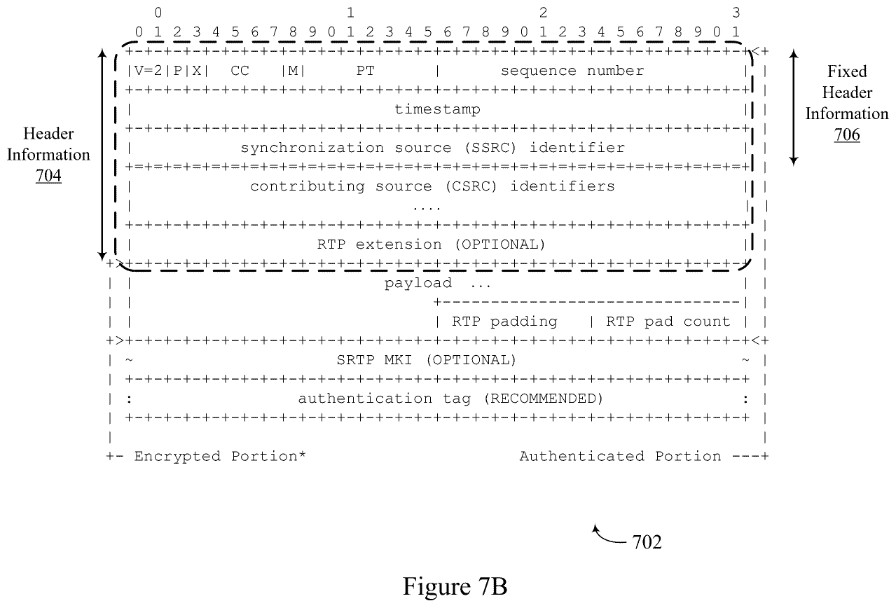

FIGS. 7A and 7B illustrate an example RTP packet format 701 and an example SRTP packet format 702, respectively. The RTP packet format 701 and the SRTP packet format 702 may implement or be implemented by aspects of the wireless communications system 100 and the CN XRM architecture 200. For example, as described with reference to FIGS. 1 and 2, an RTP sender and an RTP receiver may communicate XR traffic (e.g., RTP packets, SRTP packets) as PDU sets according to the RTP packet format 701 and/or the SRTP packet format 702. Header information 704 and fixed header information 706 may have a same format and may be common (e.g., shared) for both the RTP packet format 701 and the SRTP packet format 702.

SRTP is a secured version of RTP, providing encryption (via payload confidentiality), message authentication and integrity protection (via PDU, e.g., headers and payload, signaling), and replay attack protection. Similar to RTP, the SRTP protocol is a secure real-time control protocol (SRTCP). This provides the same functions to its RTCP counterpart. As such, in vanilla SRTP versions, RTP header information is still accessible but non-modifiable, whereas the payload is encrypted. These security provisions are illustrated in part in the bottom portion of FIG. 7B. Further, the key exchange and additional security parameters necessary to use SRTP are based upon the datagram transport layer security (DTLS) key exchange procedure. SRTP is used for these reasons as the transport protocol for media in the WebRTC stack which ensures secure RTC multimedia communications over web browser interfaces. The header information 704 (including header extensions) and the fixed header information 706 is briefly summarized for the RTP packets and the SRTP packets as follows.

The fixed header information 706 includes V, P, X, CC, M, PT, a sequence number, a timestamp, and a synchronization source (SSRC) identifier. V is 2 bits indicating the protocol version used. P is a 1 bit field indicating that one or more zero-padded octets at the end of the payload are present, whereby, among others, the padding may be used for fixed-sized encrypted blocks or for carrying multiple RTP/SRTP packets over lower layer protocols. X is 1 bit indicating that the standard fixed RTP/SRTP header will be followed by an RTP header extension usually associated with a particular data/profile that will carry more information about the data (e.g., the frame marking RTP header extension for video data, or generic RTP header extensions such as the RTP/SRTP extended protocol). CC is 4 bits indicating number of contributing media sources that follow the fixed header.

M is 1 bit intended to mark an information frame boundaries in the packet stream, whose behavior is exactly specified by RTP profiles (e.g., H.264, H.265, H.266, AV1, etc.). PT is 7 bits indicating the payload type, which in case of video profiles is dynamic and negotiated by means of SDP (e.g., 96 for H.264, 97 for H.265, 98 for AV1, etc.). Sequence number is 16 bits indicating the sequence number which increments by one with each RTP data packet sent over a session. Timestamp is 32 bits indicating timestamp in ticks of the payload type clock reflecting the sampling instant of the first octet of the RTP data packet (associated for video stream with a video frame), whereas the first timestamp of the first RTP packet is selected at random. SSRC identifier is 32 bits indicating a random identifier for the source of a stream of RTP packets forming a part of the same timing and sequence number space, such that a receiver may group packets based on synchronization source for playback.

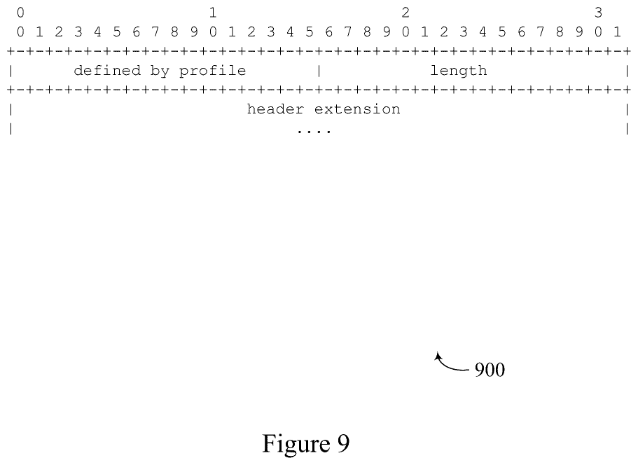

The header information 704 includes the fixed header information 706 as well as a contributing source identifier (CSRC). The CSRC identifier is a list of up to 16 CSRC items of 32 bits each given the amount of CSRC mixed by RTP mixers within the current payload as signaled by the CC bits; the list identifies the contributing sources for the payload contained in this packet given the SSRC identifiers of the contributing sources. In some examples, the header information 704 further includes an RTP header extension as illustrated with reference to FIG. 9.

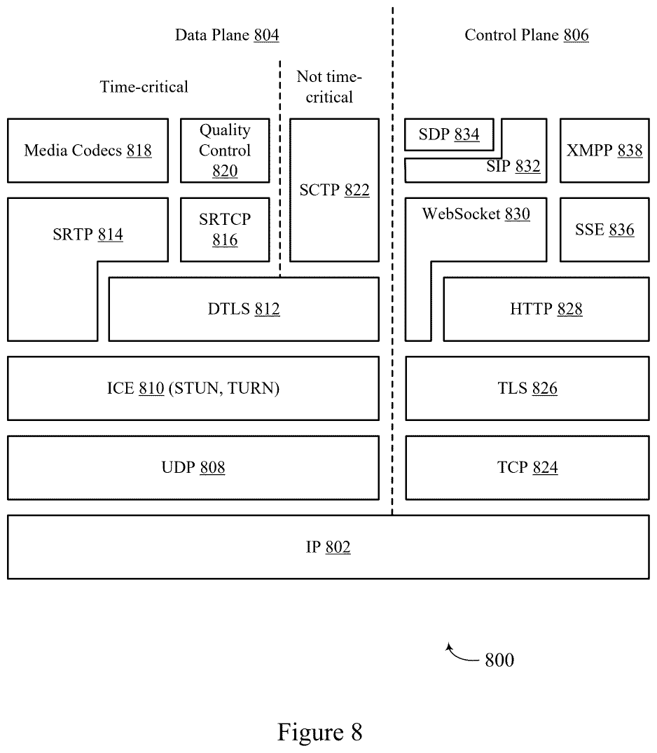

FIG. 8 illustrates an example WebRTC stack 800 in accordance with aspects of the present disclosure. An RTP sender and an RTP receiver may communicate XR traffic (e.g., RTP packets, SRTP packets) as PDU sets as described herein according to the WebRTC stack 800.

As illustrated, an IP layer 802 carries signaling from a data plane 804 and a control plane 806. The data plane 804 includes functions for a UDP 808, Interactive Connectivity Establishment (ICE) 810, DTLS 812, SRTP 814, SRTCP 816, media codecs 818, quality control 820, and SCTP 822. ICE 810 may use the Session Traversal Utilities for NAT (STUN) protocol and TURN to address real-time media content delivery across heterogeneous networks and NAT rules and firewalls. The SCTP 822 may be dedicated as an application data channel and may be non-time critical. The SRTP 814 and elements of control, e.g., SRTCP 816, encoding, e.g., media codecs 818, and QoS, e.g., quality control 820, may be dedicated to time-critical transport. The control plane 806 includes functions for TCP 824, Transport Layer Security (TLS) 826, Hypertext Transfer Protocol (HTTP) 828, WebSocket 830, SIP 832, SDP 834, Server-sent Events (SSE) 836, and Extensible Messaging and Presence Protocol (XMPP) 838.

The data plane 804 may be established over a single application session (e.g., a 5-tuple) multiplexing the transport of media (e.g., video, audio, haptic media codec payloads), user plane quality control and feedback based on RTCP messages, and WebRTC data channels (e.g., application data such as user chat messages, notifications, user inputs, user actions, user pose, and the like) over SCTP 822 and/or DTLS 812.

FIG. 9 illustrates an example RTP/SRTP header extension format 900 in accordance with aspects of the present disclosure. The RTP/SRTP header extension format 900 illustrates an example format of an RTP extension header included as part of RTP packets and SRTP packets alike, such as RTP packets and SRTP packets described with reference to FIGS. 7-1 and 7-2.

In both RTP and SRTP, only one RTP extension header may be appended to the fixed header information 704. However, for both RTP and SRTP, extensions to base protocols exist to allow for multiple RTP header extensions of predetermined types to be appended to the fixed header information 704 of the protocols. In some examples, RTP header extensions produced at a source (e.g., an RTP sender) may be ignored by the destination endpoints (e.g., RTP receivers) that do not have the knowledge to interpret and process the RTP header extensions transmitted by the source endpoint.

The RTP/SRTP header extension format 900 includes a header extension field, which has a variable length and is present if the X bit is marked. The header extension field is appended to the fixed header information 704 after the CSRC list if present. The RTP/SRTP header extension format 900 is 32-bit aligned and includes the following fields: 1) a 16-bit extension identifier defined by a profile and usually negotiated and determined via the SDP signaling mechanism; 2) a 16-bit length field describing the header extension length in 32-bit multiples excluding the first 32 bits corresponding to the 16-bit extension identifier and the 16-bit length field itself; and 3) a 32-bit aligned header extension raw data field formatted according to an RTP header extension identifier-specified format.

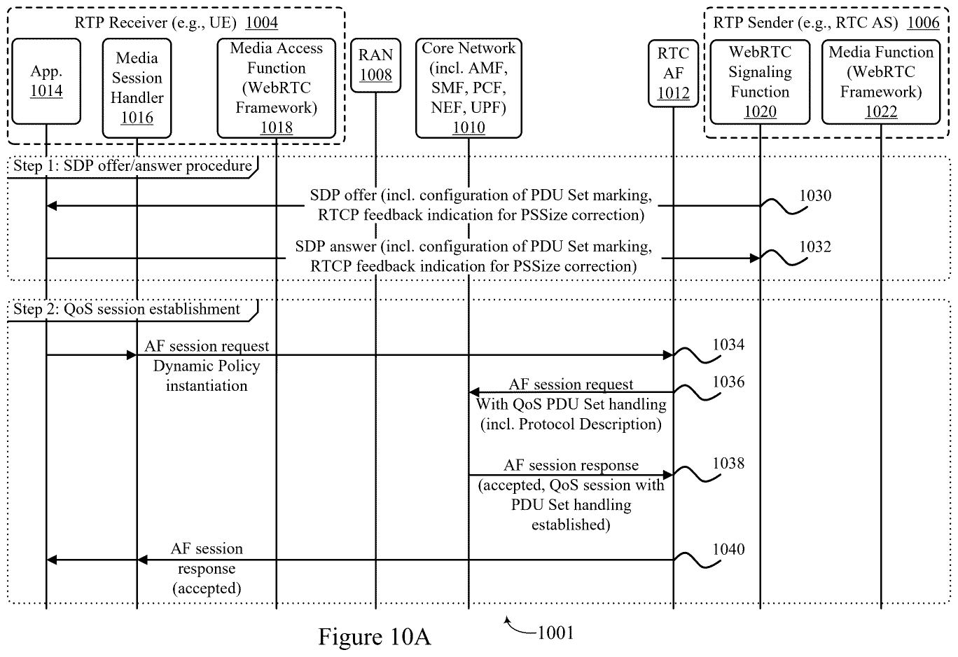

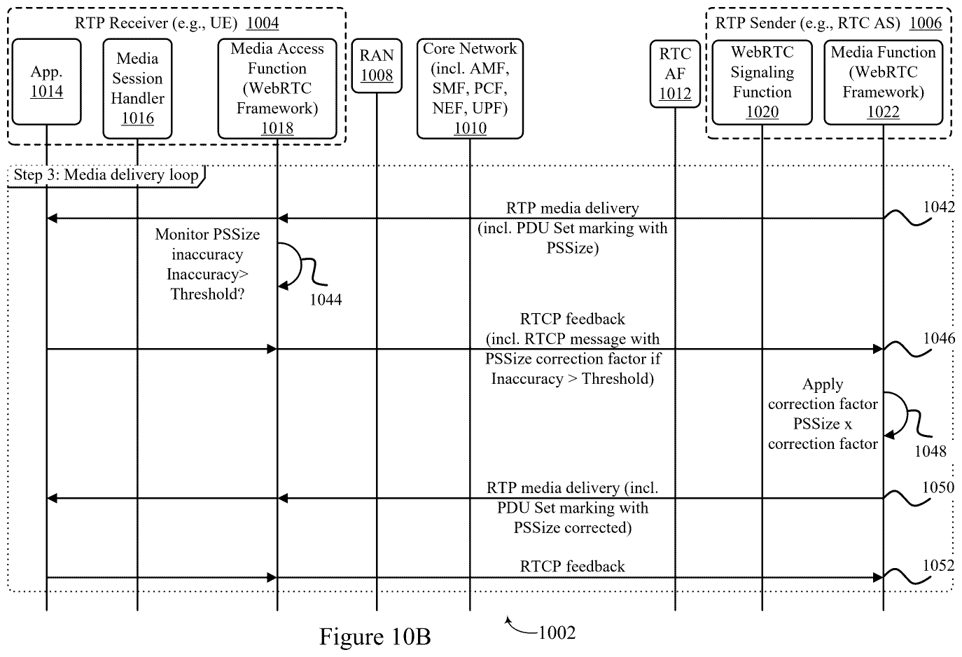

FIGS. 10A and 10B illustrate a first portion 1001 and a second portion 1002, respectively, of an RTP session in accordance with aspects of the present disclosure. The RTP session may implement or be implemented by aspects of the wireless communications system 100 and the CN XRM architecture 200. For example, the RTP session illustrates communication of XR traffic between RTC endpoints over a 5G RTC system. Establishment of the RTC session may be initiated and completed based on SDP signaling and offer/answer messages between the two RTC endpoints over an RTC-4 interface. The RTC endpoints may include or be an example of a UE and an RTC AS, a UE and a peer UE communicating via an RTC AS, or the like, among other examples.

As illustrated in FIGS. 10A and 10B, the RTC endpoints include an RTP receiver 1004 and an RTP sender 1006. In implementations, an RTC endpoint may be a device that functions as both an RTP sender and an RTP receiver. The 5G RTC system includes a RAN 1008, a CN 1010, and an RTC AF 1012. The RTP receiver 1004 may include or be an example of a UE 104 described herein and includes an application 1014, a media session handler (MSH) 1016, and a media access function (MAF) 1018, which may include a WebRTC framework. The RTP sender 1006 may include or be an example of an RTC AS that includes a WebRTC signaling function 1020 (e.g., as described with reference to FIG. 5) and a media function 1022, which may include a WebRTC framework. The CN 1010 includes an AMF, an SMF, a PCF, an NEF, and a UPF.

The RTP sender 1006 and the RTP receiver 1004 may communicate directly (e.g., via IP/UDP encapsulation) or indirectly (e.g., via STUN or TURN relaying post-ICE candidate negotiation if direct connectivity is not possible due to firewall or NAT routing rules) over RTP and RTCP in the RTP session. Initially, an ASP may provision the RTC AF 1012 and/or the RTC sender 1006 with configurations (e.g., SDP offer/answer options including protocol formats, payload types, codecs, supported RTP header extensions, supported RTCP messages, media grouping/bundling, RTP media session parameters, and the like), dynamic policies (e.g., QoS session configuration parameters), event reporting (e.g., QoE and consumption metrics reporting), and/or network assistance from the 5GS. In some examples, the ASP provisioning the RTC AF 1012 and/or the RTC sender 1006 may include dynamic policies templates and SDP offer/answer configurations with support for PDU set QoS handling and PDU set marking over RTP header extensions.

Step 1 includes configuration of the RTP session negotiated by the RTP sender 1006 and the RTP receiver 1004 using an SDP offer/answer procedure. The RTP sender 1006 and the RTP receiver 1004 negotiate RTP media, protocol, header extensions, RTCP feedback message configurations, and format capabilities as part of the SDP offer/answer procedure. The configuration for RTCP feedback messages may indicate parameters for indicating correction factors for PSSize indication correction, which may include, but are not limited to, a correction factor threshold cf-threshold associated with an inaccuracy condition, a threshold quantity of RTCP feedback message transmissions, and a threshold time interval between consecutive RTCP feedback message transmissions. In some examples, the configuration for the RTCP feedback messages may further indicate whether the correction factor is to be indicated as part of an RTCP-RTPFB message, an RTCP-PSFB packet, or an RTCP-XR packet.

For example, the RTP receiver 1004 and the RTP sender 1006 may utilize the SDP offer/answer procedure to agree on a value of the correction factor threshold associated with the inaccuracy condition. The correction factor threshold may represent the inaccuracy condition as a maximum allowed variation of an indicated PSSize compared to an actual PSSize, referred to herein as a PSSize variation. The correction factor threshold may be defined as, or otherwise based on, a ratio, such as

$$\frac{{PSSize}_{actual}}{{PSSize}_{indicated}} .$$

An example RTCP feedback message configuration for indicating correction factors for PSSize indication correction is shown below.

```
  ‘‘‘
  # RTCP correction factor feedback if received PDU Set size > PSSize by
more than 2%
  cf-threshold = 1.02
  # maximum 3 RTCP correction factor feedback messages when threshold
condition met
  max-num-fb = 3
  # min. interval between RTCP correction feedback messages is 1 minutes
/ 60 s / 60000 ms
  time-interval = 60000
  ‘‘‘
```

At 1030, the RTP sender 1006 transmits, and the RTP receiver 1004 receives, an SDP offer (e.g., an SDP offer message) that includes a configuration for PDU set marking via RTP header extensions (e.g., including PSSize information and indications) and/or a configuration for RTCP feedback messages. For instance, the SDP offer may indicate configuration parameters supported or preferred by the RTP sender 1006.

At 1032, the RTP receiver 1004 transmits, and the RTP sender 1006 receives, an SDP answer in response to the SDP offer. The SDP answer includes a configuration for PDU set marking and/or a configuration for RTCP feedback messages including parameters for indicating correction factors for PSSize indication correction as described herein. For instance, the SDP answer indicates configuration parameters supported or preferred by the RTP receiver 1004 based on configuration parameters indicated in the SDP offer.

The SDP offer/answer procedure may be intermediated by a signaling server accessible by both RTP sender 1006 and/or RTP receiver 1004. An example of such a signaling server may be the WebRTC signaling function 1020. An example of STUN or TURN relaying functionality post-ICE candidate negotiation may be implemented via an ICE function of an RTC AS (e.g., as described with reference to FIG. 5).

Once the SDP offer/answer procedure is completed between the RTP sender 1006 and the RTP receiver 1004 based on the configured subset of options as per ASP provisioning, the media, protocol, format, and codec parameters for the RTP session are established and configured in step 2. These parameters include RTP header extensions (e.g., PDU set marking enablement) as well as RTCP message support (e.g., RTCP messages for indicating a PSSize correction factor). The RTP receiver 1004 may request, via the RTC AF 1012, a session with QoS parameters (e.g., as configured by the ASP) based on a dynamic policy instance. For example, at 1034, the QoS allocation is determined for the RTC session based on the SDP-determined 5-tuple and media service access information provided by the application 1014 to the MSH 1016 (e.g., over an RTC-6 interface). The MSH 1016 then requests QoS assistance from the RTC AF 1012 by instantiating a policy template as a dynamic policy. The media AF 1018 validates the dynamic policy request and requests, to the 5GS (e.g., by means of existing N5/N33 interfaces and associated policy authorization APIs) via the RTC AF 1012, an AF session with QoS on behalf of the RTC session.

At 1036, in response to the AF session request received at 1034, the RTC AF 1012 transmits an AF session request with QoS PDU set handling to the CN 1010. This AF session request further includes a protocol description including details about the RTP session, media components, payload types, and RTP header extension for PDU Set marking. The protocol description information element for RTP header extension for PDU set marking further includes the format of the RTP header extension (e.g., a 1-byte format as described with reference to FIG. 3 or a 2-byte format as described with reference to FIG. 4) as well as the presence of optional fields, such as PSSize and/or NPDS.

At 1038, the CN 1010 transmits an AF session response to the RTC AF 1012 to indicate whether the AF session request is accepted. If the AF session request is accepted, the QoS session with PDU set handling is established, and at 1040, the RTC AF 1012 notifies the MSH 1016 (e.g., via RTC-5 interface), and the MSH 1016 notifies the application 1014 (e.g., via RTC-6 interface). Additionally, in some examples, the 5GS may configure, using control signaling, the QoS flow and NG-RAN QoS profile including the protocol description, PSDB, and PSER associated with the PDU set QoS handling.

Once the QoS flow(s) are established and the session policy is granted by the CN 1010, media delivery over the 5G RTC system may proceed in step 3 illustrated in FIG. 10B. A media delivery loop between the RTP sender 1006 and the RTP receiver 1004 may begin with RTP multimedia traffic over an RTC-4 interface. For example, at 1042, RTP content (e.g., RTP packets) may be encoded by the RTP sender 1006 (e.g., in downlink) according to the SDP configuration and protocol description to include PDU set marking via RTP header extensions with PSSize indications. The RTP sender 1006 may derive a respective PSSize for each PDU set and may mark (e.g., indicate) an RTP header of each PDU set with the respective PSSize. Thus, each PDU set transmitted by the RTP sender 1006 may include, in the corresponding RTP header, an indication (e.g., a value in bytes) of a respective PSSize.

At 1044, the RTP receiver 1004 may monitor PSSize variations for one or more PDU sets received from the RTP sender 1006. To obtain the PSSize variation for a PDU set, the RTP receiver 1004 may compare an indicated PSSize value in the RTP header extension of a received PDU set to an actual number of bytes of the received PDU set, including IP/UDP/RTP header encapsulation overheads. In some examples, the RTP receiver 1004 may monitor multiple PSSize variations, e.g., for multiple PDU sets. The RTP receiver 1004 may aggregate the PSSize variations over one or more PDU sets to account for sampling size variations, where the quantity of the one or more PDU sets may be per implementation of the RTP receiver 1004.

The RTP receiver 1004 may determine that the inaccuracy condition is satisfied if the PSSize variation meets the correction factor threshold configured during the SDP offer/answer procedure (e.g., as indicated in the RTCP feedback message configuration). For example, if the correction factor threshold is configured to be a value greater than 1.0, the inaccuracy condition may be satisfied when a value of the PSSize variation is greater than the correction factor threshold. In another example, if the correction factor threshold is configured to be a value less than 1.0, the inaccuracy condition may be satisfied when a value of the PSSize variation is less than the correction factor threshold. When the RTP receiver 1004 determines that the inaccuracy condition is satisfied, the RTP receiver 1004 may trigger transmission of an RTCP feedback message to the RTP sender 1006 at 1046.

The RTCP feedback message transmitted by the RTP receiver 1004 at 1046 may include an indication of a correction factor (e.g., a correction factor value) for PSSize indications. For example, the indication of the correction factor may be a floating point numeral. The RTP sender 1006 receives the RTCP feedback message with the correction factor and, at 1048, applies the correction factor (e.g., by multiplication) to the future PSSize indications of upcoming PDU Sets. For example, at 1048, the RTP sender 1006 may calculate a respective PSSize for one or more PDU sets to be transmitted to the RTP sender 1006. For each of the one or more PDU sets, the RTP sender 1006 may multiply the calculated PSSize by the correction factor indicated in the RTCP feedback message to obtain a corrected PSSize. The RTP sender 1006 may mark the respective RTP headers of each of the one or more PDU sets with the corresponding corrected PSSize. At 1050, the RTP sender 1006 may transmit, and the RTP receiver 1004 may receive, RTP media including the one or more PDU sets marked with the corrected PSSizes.

At 1052, the RTP receiver 1004 may, in some examples, monitor PSSize variations for the one or more PDU sets received at 1050. If the RTP receiver 1004 determines that the PSSize variations satisfy the correction factor and/or that the inaccuracy condition is met, the RTP receiver 1004 may transmit an RTCP feedback message to the RTP sender 1006 at 1052 indicating an additional correction factor. The RTP receiver 1004 may discard the previously-received correction factor and may instead apply the additional correction factor to subsequent PDU sets to be transmitted to the RTP receiver 1004.

In implementations, the RTP receiver 1004 may be configured (e.g., during the SDP offer/answer procedure) to continuously monitor PSSize variations for any or all PDU sets received from the RTP sender 1006 and indicate a correction factor to the RTP sender 1006 any time the inaccuracy condition is met. A detection event may be defined as the RTP receiver 1004 determining that the inaccuracy condition is met and/or that a PSSize variation satisfies the correction factor threshold. Alternatively, or if the correction factor threshold is not configured (e.g., during the SDP offer/answer procedure), the RTP receiver 1004 may be configured (e.g., during the SDP offer/answer procedure) to indicate the correction factor only once, such as at the beginning of the RTP session or periodically. In the latter example, the RTP receiver 1004 may be configured (e.g., during the SDP offer/answer procedure) with a threshold quantity of RTCP feedback message transmissions or a threshold time interval between consecutive RTCP feedback message transmissions.

For example, the RTP receiver 1004 is limited to a maximum quantity of RTCP feedback messages for indicating correction factors. The limitation may be based on the SDP configuration derived from the SDP offer-answer procedure and may include a value of the maximum quantity of RTCP feedback messages, e.g., by a max-num-fb=3 RTCP attribute as part of SDP offer/answer. The maximum quantity of RTCP feedback messages may be applicable for each detection event to avoid excessive RTCP feedback messaging. In some implementations, the RTP receiver 1004 maintains an RTCP feedback message counter and increases the counter with each RTCP feedback message transmission, e.g., up to the maximum quantity of RTCP feedback messages. Additionally, or alternatively, the RTP receiver 1004 may reset the counter to zero if the inaccuracy condition is no longer being met. For instance, the RTP sender 1006 may take action to adjust PSSize indications according to a previously-received correction factor, such that the PSSize variation no longer satisfies the correction factor threshold.

Additionally, or alternatively, the RTP receiver 1004 may be limited to transmit RTCP feedback messages for indicating correction factors according to a time duration or interval, such as a threshold time interval between consecutive RTCP feedback message transmissions. For example, the RTP receiver 1004 may be configured to indicate a correction according to a transmission interval (or alternatively, frequency) of time-interval value. In such instances, the transmission interval is applied at each detection even to limit the amount of RTCP feedback messages and avoid network congestion. The value may be an integer corresponding to a time unit value such as milliseconds, seconds, or the like. For example, time-interval=120000 expressed in milliseconds in the SDP attributes corresponds to the RTP receiver 1004 sending an RTCP feedback message indicating a correction factor every 2 minutes.

In some examples, the RTP receiver 1004 may be configured with both a maximum quantity of RTCP feedback message transmissions and a threshold time interval. In such implementations, the time intervals may be applicable to RTCP feedback message transmissions up to the maximum quantity of RTCP feedback messages when the inaccuracy condition is met.

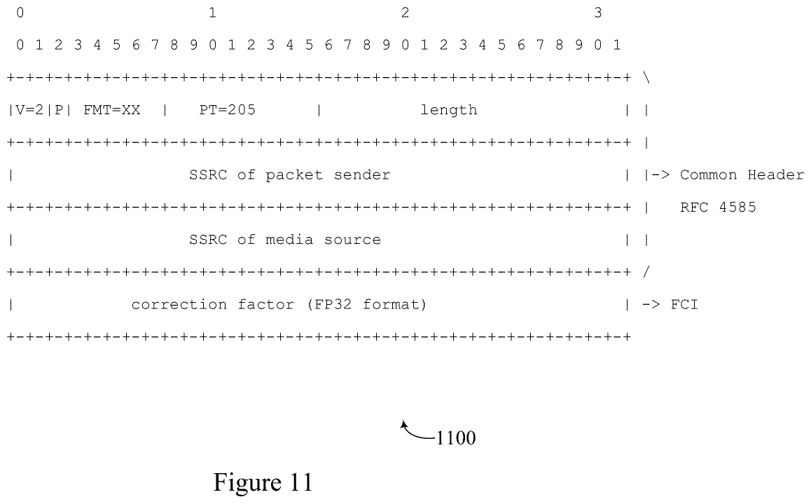

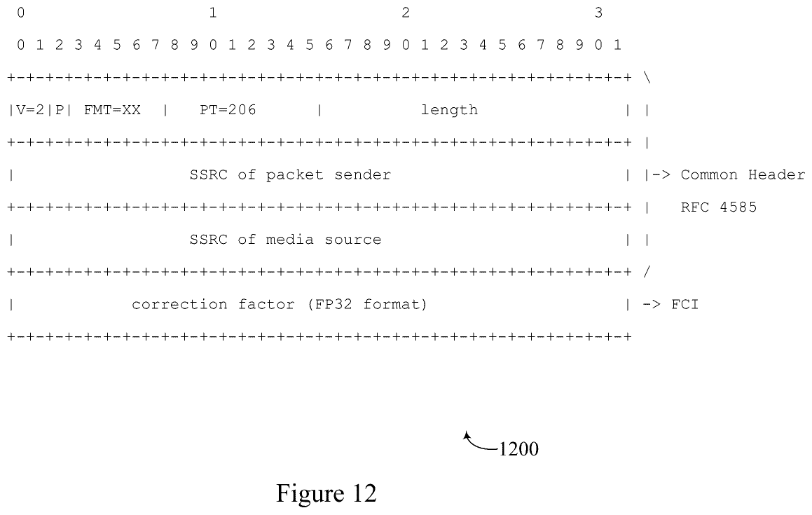

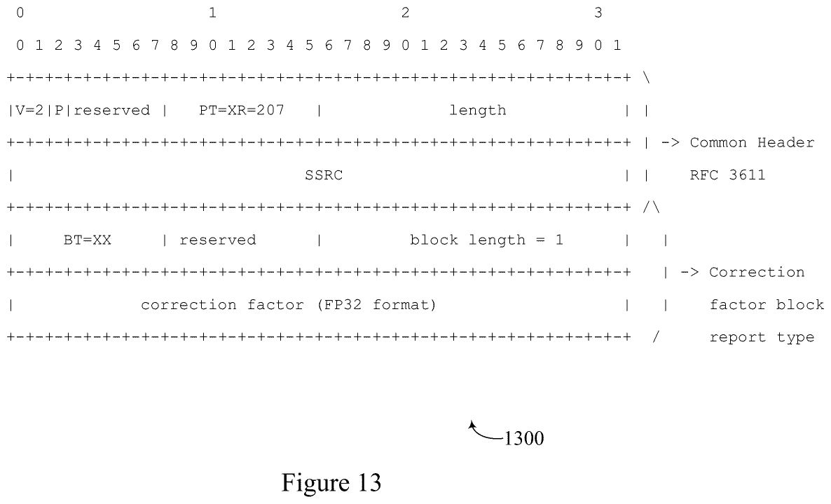

FIGS. 11-13 illustrate example RTCP feedback message encoding schemes and formats for indicating PSSize correction factors as described herein. For example, as described with reference to FIGS. 1-10, an RTP receiver may utilize an RTCP feedback message to indicate a correction factor to an RTP sender according to an encoding scheme and format that is based on the type of the RTCP feedback message. FIG. 11 illustrates an example RTCP-RTPFB message format 1100 used when the RTCP feedback message is an RTCP-RTPFB message. FIG. 12 illustrates an example RTCP-PSFB message format 1200 used when the RTCP feedback message is an RTCP-PSFB packet. FIG. 13 illustrates an example RTCP-XR report block format 1300 used when the RTCP feedback message is an RTCP-XR packet.

In the example of FIG. 11, the correction factor is indicated within an RTCP-RTPFB message, applicable to the transport-layer level. The correction factor is 32-bit aligned and defined as per RFC 4585. Additionally, FIG. 11 illustrates an example syntax realization of the FCI of the RTCP-RTPFB message applicable to the correction factor. That is, the correction factor may include or be an example of a 32-bit IEEE 754 floating point single precision representation (FP32).

The RTCP-RTPFB message configured according to the RTCP-RTPFB message format 1100 includes the following fields.

Version (V) [2 bits]: Identifies the correspond RTP protocol version (currently version 2).

Padding (P) [1 bit]: If set, indicates that the RTCP-RTPFB message contains additional padding octets at the end that are not part of control information, but are included in a length field.

Feedback Message Type (FMT) [5 bits]: Identifies the type of RTCP feedback message and is interpreted relative to the RTCP feedback message type (e.g., RTCP-RTPFB, RTCP-PSFB), with values defined either in RFC 4585 or registered by IANA. When the RTCP-RTPFB message indicates a correction factor as described herein, the FMT may be assigned by IANA to correspond to an identifier of “3gpp-correction-factor-pssize”, as, for example, value 12 as currently available in the IANA RTPFB registry.

Payload Type (PT) [8 bits]: Identifies the RTCP packet type as being RTCP-RTPFB (e.g., 205).

Length [16 bits]: Length of the RTCP-RTPFB message in 32-bit words minus one, including the header and any padding.

SSRC of packet sender [32 bits]: Synchronization source identifier for an originator of the RTCP-RTPFB message (e.g., the RTP receiver).

SSRC of media source [32 bits]: Synchronization source identifier of the media source to which the RTCP-RTPFB message is related (e.g., SSRC of media marked with RTP header extensions for PDU set marking).

Feedback Control Information (FCI)=Correction Factor [32 bits]: Feedback message payload. In the example of FIG. 11, the FCI is the correction factor in single-precision floating point format (FP32).

An example SDP attribute in the SDP offer/answer procedure corresponding to an RTCP-RTPFB realization of the correction factor is listed below according to SDP extendable definitions of IETF RFC 4585:
# RTCP-RTPFB for correction factor for PSSize with correction factor set to 1.02, or alternatively 2% threshold condition

$$a = rtcp - fb : * 3 gpp - correction - factor - pssize cf - threshold 1.02$$

In the example of FIG. 12, the correction factor is indicated within an RTCP-PSFB packet, applicable to a payload-specific feedback level. As such, the corresponding correction factor is 32-bit aligned and defined as per RFC 4585 as illustrated in FIG. 12. Further, FIG. 12 illustrates an example syntax realization of the FCI of the RTCP-PSFB applicable to the correction factor, e.g., a 32-bit IEEE 754 floating point single precision representation (FP32).

Since, per IETF RFC 4585, RTCP-RTPFB messages and RTCP-PSFB packets share a same packet format and header syntax, the RTCP-PSFB packet will have the same fields and syntax as the RTCP-RTPFB message illustrated in FIG. 11. However, as illustrated in FIG. 12, the PT may differ and may correspond to the RTCP-PSFB PT, e.g., 206. Additionally, the FMT may be assigned by IANA and may correspond to an identifier of “3gpp-correction-factor-pssize”, as, for example, value 12, as currently available in the IANA PSFB registry.

An example SDP attribute in the SDP offer/answer procedure corresponding to an RTCP-PSFB realization of the correction factor is listed below according to SDP extendable definitions of IETF RFC 4585:
# RTCP-PSFB for correction factor for PSSize with correction factor set to 1.02, or alternatively 2% threshold condition

$$a = rtcp - fb : * 3 gpp - correction - factor - pssize cf - threshold 1.02$$

In the example of FIG. 13, the correction factor is indicated within an RTCP-XR packet. As such, the corresponding correction factor is 32-bit aligned and defined as per RFC 3611 as a report block as part of the RTCP-XR packet as illustrated in FIG. 13. Additionally, FIG. 13 illustrates an example report block syntax realization applicable to the correction factor, as a 32-bit IEEE 754 floating point single precision representation (FP32).

The RTCP-XR report block configured according to the RTCP-XR report block format 1300 includes the following fields.

Version (V) [2 bits]: Identifies the corresponding RTP protocol version (currently version 2).

Padding (P) [1 bit]: If set, indicates that the RTCP-XR report block contains additional padding octets at the end that are not part of control information but are included in a length field.

Reserved [5 bits]

Payload Type (PT) [8 bits]: Identifies the RTCP packet type as being RTCP-XR, e.g., 207.

Length [16 bits]: Length of this packet in 32-bit words minus one, including the header and any padding.

SSRC [32 bits]: Synchronization source identifier for the originator of this RTCP-XR packet (e.g., RTP receiver in the context herein).

Block Type [6 bits]: Identifies the block format (e.g., the RTCP-XR report block format 1300) and may correspond to an IANA assigned identifier mapped to “3gpp-correction-factor-pssize” block type, e.g., as value 36, as next available in the IANA RTCP-XR registry of block types.

Reserved [8 bits]

Block Length [16 bits]: The length of the RTCP-XR report block, including the header, in 32-bit words minus one. In this example, this corresponds to 1.

Correction Factor [32 bits]: Report block payload. In the example of FIG. 13, the report block payload is the correction factor in single-precision floating point format (FP32), as, for example, the determined ratio between an actual PSSize and an indicated PSSize.

An example SDP attribute in the SDP offer/answer procedure corresponding to an RTCP-XR report block realization of the correction factor is listed below according to SDP extendable definitions of IETF RFC 4585:
# RTCP-XR for correction factor for PSSize with correction factor set to 1.02, or alternatively 2% threshold condition, Limited to RTCP-XR feedback to an interval of at Least 60 seconds and maximum 3 feedback reports per detection event

$$a = rtcp - xr : * 3 gpp - correction - factor - pssize cf - threshold = 1.02 time - interval = 60000 max - number - fb = 3$$

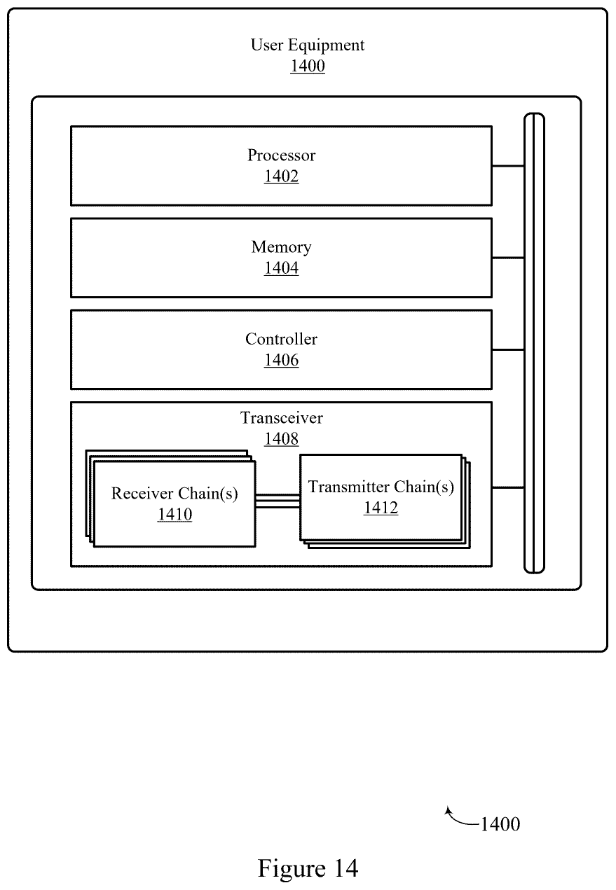

FIG. 14 illustrates an example of an apparatus 1400 in accordance with aspects of the present disclosure. The apparatus 1400 may include or be an example of a UE 104 as described herein. The apparatus 1400 may include a processor 1402, a memory 1404, a controller 1406, and a transceiver 1408. The processor 1402, the memory 1404, the controller 1406, or the transceiver 1408, or various combinations thereof or various components thereof may be examples of means for performing various aspects of the present disclosure as described herein. These components may be coupled (e.g., operatively, communicatively, functionally, electronically, electrically) via one or more interfaces.

The processor 1402, the memory 1404, the controller 1406, or the transceiver 1408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1402 may include an intelligent hardware device (e.g., a general-purpose processor, a DSP, a CPU, an ASIC, an FPGA, or any combination thereof). In some implementations, the processor 1402 may be configured to operate the memory 1404. In some other implementations, the memory 1404 may be integrated into the processor 1402. The processor 1402 may be configured to execute computer-readable instructions stored in the memory 1404 to cause the apparatus 1400 to perform various functions of the present disclosure.

The memory 1404 may include volatile or non-volatile memory. The memory 1404 may store computer-readable, computer-executable code including instructions when executed by the processor 1402 cause the apparatus 1400 to perform various functions described herein. The code may be stored in a non-transitory computer-readable medium such as the memory 1404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1402 and the memory 1404 coupled with the processor 1402 may be configured to cause the apparatus 1400 to perform one or more of the functions described herein (e.g., executing, by the processor 1402, instructions stored in the memory 1404). For example, the processor 1402 may support wireless communication at the apparatus 1400 in accordance with examples as disclosed herein. The apparatus 1400 may be configured to or operable to support a means for receiving, from an RTP device, one or more PDU sets, where each PDU set of the one or more PDU sets has a respective PDU set size and includes a respective PDU set size indication; determining a correction factor for PDU set size indications based on a comparison between the respective PDU set sizes and the respective PDU set size indications; and transmitting, to the RTP device, the correction factor based on an inaccuracy condition being satisfied.

Additionally, the apparatus 1400 may be configured to support any one or combination of the method further comprises transmitting the correction factor in an RTCP feedback message. The correction factor comprises an FCI field, and the RTCP feedback message comprises one of an RTCP-RTPFB or an RTCP-PSFB packet. The correction factor comprises a report block field, and the RTCP feedback message comprises an RTCP-XR packet. The method further comprises communicating, as part of an SDP offer-answer procedure with the RTP device, a configuration for the RTCP feedback message. The configuration indicates at least one of a correction factor threshold associated with the inaccuracy condition, a threshold quantity of RTCP feedback message transmissions, or a threshold time interval between consecutive RTCP feedback message transmissions. The correction factor comprises a floating-point numeral. Determining the correction factor further comprises obtaining, based on the comparison, a ratio of the respective PDU set sizes and the respective PDU set size indications, where the inaccuracy condition is satisfied based on the ratio satisfying a threshold. The RTP device comprises an RTP sender device and the apparatus 1400 comprises an RTP receiver device.

Additionally, or alternatively, the apparatus 1400 may support at least one memory (e.g., the memory 1404) and at least one processor (e.g., the processor 1402) coupled with the at least one memory and configured to cause the apparatus 1400 to receive, from an RTP device, one or more PDU sets, where each PDU set of the one or more PDU sets has a respective PDU set size and includes a respective PDU set size indication, and transmit, to the RTP device and in response to an inaccuracy condition being satisfied, a correction factor for one or more PDU set size indications, where the correction factor is based on a comparison between the respective PDU set size and the respective PDU set size indication.

Additionally, the apparatus 1400 may be configured to support any one or combination of to transmit the correction factor, the at least one processor is configured to cause the apparatus 1400 to transmit the correction factor in an RTCP feedback message. Additionally, or alternatively, the correction factor includes an FCI field, and the RTCP feedback message includes one of an RTCP-RTPFB or an RTCP-PSFB packet. Additionally, or alternatively, the correction factor includes a report block field, and the RTCP feedback message includes an RTCP-XR packet. Additionally, or alternatively, the at least one processor is configured to cause the apparatus 1400 to communicate, as part of an SDP offer-answer procedure with the RTP device, a configuration for the RTCP feedback message. Additionally, or alternatively, the configuration indicates at least one of a correction factor threshold associated with the inaccuracy condition, a threshold quantity of RTCP feedback message transmissions, or a threshold time interval between consecutive RTCP feedback message transmissions. Additionally, or alternatively, the correction factor includes a floating-point numeral. Additionally, or alternatively, to determine the correction factor, the at least one processor is configured to cause the apparatus 1400 to obtain, based on the comparison, a ratio of the respective PDU set sizes and the respective PDU set size indications, where the inaccuracy condition is satisfied based on the ratio satisfying a threshold. Additionally, or alternatively, the RTP device includes an RTP sender device and the apparatus 1400 includes an RTP receiver device.

Additionally, or alternatively, the apparatus 1400 may be configured to or operable to support a means for transmitting, to an RTP device, a first one or more PDU sets, where each PDU set of the first one or more PDU sets has a respective PDU set size and includes a respective PDU set size indication; receiving, from the RTP device, a correction factor for PDU set size indications based on the first one or more PDU sets; calculating, for each PDU set of a second one or more PDU sets, a respective corrected PDU set size using the correction factor; and transmitting, to the RTP device, the second one or more PDU sets, where each PDU set of the second one or more PDU sets includes a respective corrected PDU set size indication based on the respective corrected PDU set sizes.

Additionally, or alternatively, the apparatus 1400 may be configured to support any one or combination of the method further comprises receiving the correction factor within an RTCP feedback message. The correction factor comprises an FCI field, and the RTCP feedback message comprises one of an RTCP-RTPFB or an RTCP-PSFB packet. The correction factor comprises a report block field, and the RTCP feedback message comprises an RTCP-XR packet. The method further comprises communicating, as part of an SDP offer-answer procedure with the RTP device, a configuration for the RTCP feedback message. The configuration indicates at least one of a correction factor threshold associated with the inaccuracy condition, a threshold quantity of RTCP feedback message transmissions, or a threshold time interval between consecutive RTCP feedback message transmissions. The correction factor comprises a floating-point numeral. The method further comprises receiving a second correction factor for PDU set size indications based on the second one or more PDU sets; and calculating a second corrected PDU set size for a subsequent one or more PDU sets using the second correction factor. The RTP device comprises an RTP receiver device and the apparatus 1400 comprises an RTP sender device.

Additionally, or alternatively, the apparatus 1400 may support at least one memory (e.g., the memory 1404) and at least one processor (e.g., the processor 1402) coupled with the at least one memory and configured to cause the apparatus 1400 to transmit, to an RTP device, a first one or more PDU sets, where each PDU set of the first one or more PDU sets has a respective PDU set size and includes a respective PDU set size indication, receive, from the RTP device, a correction factor for PDU set size indications based on the first one or more PDU sets, calculate, for each PDU set of a second one or more PDU sets, a respective corrected PDU set size using the correction factor, and transmit, to the RTP device, the second one or more PDU sets, where each PDU set of the second one or more PDU sets includes a respective corrected PDU set size indication based on the respective corrected PDU set sizes.

Additionally, the apparatus 1400 may be configured to support any one or combination of the correction factor is received within an RTCP feedback message. Additionally, or alternatively, the correction factor includes an FCI field, and the RTCP feedback message includes one of an RTCP-RTPFB or an RTCP-PSFB packet. Additionally, or alternatively, the correction factor includes a report block field, and the RTCP feedback message includes an RTCP-XR packet. Additionally, or alternatively, the apparatus communicates, as part of an SDP offer-answer procedure with the RTP device, a configuration for the RTCP feedback message. Additionally, or alternatively, the configuration indicates at least one of a correction factor threshold associated with an inaccuracy condition, a threshold quantity of RTCP feedback message transmissions, or a threshold time interval between consecutive RTCP feedback message transmissions. Additionally, or alternatively, the correction factor includes a floating-point numeral. Additionally, or alternatively, the apparatus receives a second correction factor for PDU set size indications based on the second one or more PDU sets, and calculates a second corrected PDU set size for a subsequent one or more PDU sets using the second correction factor. Additionally, or alternatively, the RTP device includes an RTP receiver device and the apparatus 1400 includes an RTP sender device.

The controller 1406 may manage input and output signals for the apparatus 1400. The controller 1406 may also manage peripherals not integrated into the apparatus 1400. In some implementations, the controller 1406 may utilize an operating system such as iOS®, ANDROID®, WINDOWS®, or other operating systems. In some implementations, the controller 1406 may be implemented as part of the processor 1402.

In some implementations, the apparatus 1400 may include at least one transceiver 1408. In some other implementations, the apparatus 1400 may have more than one transceiver 1408. The transceiver 1408 may represent a wireless transceiver. The transceiver 1408 may include one or more receiver chains 1410, one or more transmitter chains 1412, or a combination thereof.

A receiver chain 1410 may be configured to receive signals (e.g., control information, data, packets) over a wireless medium. For example, the receiver chain 1410 may include one or more antennas to receive a signal over the air or wireless medium. The receiver chain 1410 may include at least one amplifier (e.g., a low-noise amplifier (LNA)) configured to amplify the received signal. The receiver chain 1410 may include at least one demodulator configured to demodulate the receive signal and obtain the transmitted data by reversing the modulation technique applied during transmission of the signal. The receiver chain 1410 may include at least one decoder for decoding the demodulated signal to receive the transmitted data.

A transmitter chain 1412 may be configured to generate and transmit signals (e.g., control information, data, packets). The transmitter chain 1412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1412 may also include at least one power amplifier configured to amplify the modulated signal to an appropriate power level suitable for transmission over the wireless medium. The transmitter chain 1412 may also include one or more antennas for transmitting the amplified signal into the air or wireless medium.

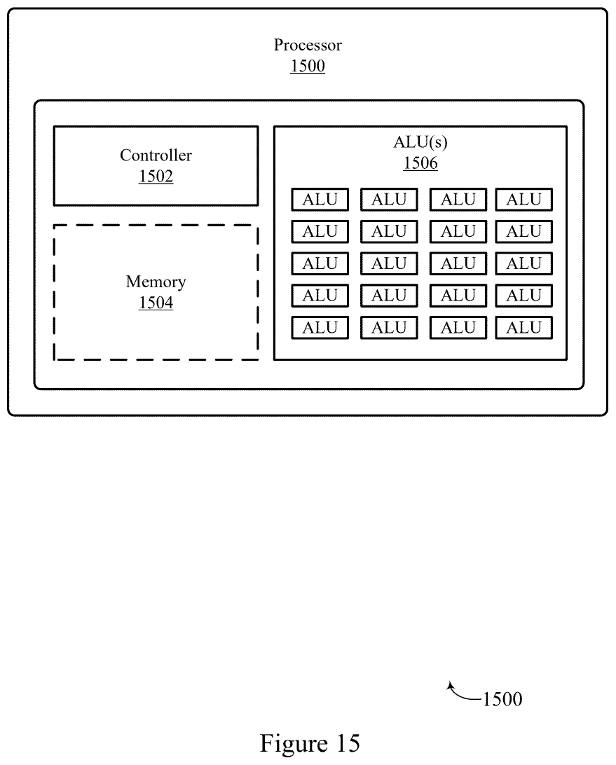

FIG. 15 illustrates an example of a processor 1500 in accordance with aspects of the present disclosure. The processor 1500 may be an example of a processor configured to perform various operations in accordance with examples as described herein. The processor 1500 may include a controller 1502 configured to perform various operations in accordance with examples as described herein. The processor 1500 may optionally include at least one memory 1504, which may be, for example, an L1/L2/L3 cache. Additionally, or alternatively, the processor 1500 may optionally include one or more arithmetic-logic units (ALUs) 1506. One or more of these components may be in electronic communication or otherwise coupled (e.g., operatively, communicatively, functionally, electronically, electrically) via one or more interfaces (e.g., buses).

The processor 1500 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1500) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1502 may be configured to manage and coordinate various operations (e.g., signaling, receiving, obtaining, retrieving, transmitting, outputting, forwarding, storing, determining, identifying, accessing, writing, reading) of the processor 1500 to cause the processor 1500 to support various operations in accordance with examples as described herein. For example, the controller 1502 may operate as a control unit of the processor 1500, generating control signals that manage the operation of various components of the processor 1500. These control signals include enabling or disabling functional units, selecting data paths, initiating memory access, and coordinating timing of operations.

The controller 1502 may be configured to fetch (e.g., obtain, retrieve, receive) instructions from the memory 1504 and determine subsequent instruction(s) to be executed to cause the processor 1500 to support various operations in accordance with examples as described herein. The controller 1502 may be configured to track memory addresses of instructions associated with the memory 1504. The controller 1502 may be configured to decode instructions to determine the operation to be performed and the operands involved. For example, the controller 1502 may be configured to interpret the instruction and determine control signals to be output to other components of the processor 1500 to cause the processor 1500 to support various operations in accordance with examples as described herein. Additionally, or alternatively, the controller 1502 may be configured to manage flow of data within the processor 1500. The controller 1502 may be configured to control transfer of data between registers, ALUs 1506, and other functional units of the processor 1500.

The memory 1504 may include one or more caches (e.g., memory local to or included in the processor 1500 or other memory, such as RAM, ROM, DRAM, SDRAM, SRAM, MRAM, flash memory, etc. In some implementations, the memory 1504 may reside within or on a processor chipset (e.g., local to the processor 1500). In some other implementations, the memory 1504 may reside external to the processor chipset (e.g., remote to the processor 1500).

The memory 1504 may store computer-readable, computer-executable code including instructions that, when executed by the processor 1500, cause the processor 1500 to perform various functions described herein. The code may be stored in a non-transitory computer-readable medium such as system memory or another type of memory. The controller 1502 and/or the processor 1500 may be configured to execute computer-readable instructions stored in the memory 1504 to cause the processor 1500 to perform various functions. For example, the processor 1500 and/or the controller 1502 may be coupled with or to the memory 1504, the processor 1500, and the controller 1502, and may be configured to perform various functions described herein. In some examples, the processor 1500 may include multiple processors and the memory 1504 may include multiple memories. One or more of the multiple processors may be coupled with one or more of the multiple memories, which may, individually or collectively, be configured to perform various functions herein.

The one or more ALUs 1506 may be configured to support various operations in accordance with examples as described herein. In some implementations, the one or more ALUs 1506 may reside within or on a processor chipset (e.g., the processor 1500). In some other implementations, the one or more ALUs 1506 may reside external to the processor chipset (e.g., the processor 1500). One or more ALUs 1506 may perform one or more computations such as addition, subtraction, multiplication, and division on data. For example, one or more ALUs 1506 may receive input operands and an operation code, which determines an operation to be executed. One or more ALUs 1506 may be configured with a variety of logical and arithmetic circuits, including adders, subtractors, shifters, and logic gates, to process and manipulate the data according to the operation. Additionally, or alternatively, the one or more ALUs 1506 may support logical operations such as AND, OR, exclusive-OR (XOR), not-OR (NOR), and not-AND (NAND), enabling the one or more ALUs 1506 to handle conditional operations, comparisons, and bitwise operations.

The processor 1500 may support wireless communication in accordance with examples as disclosed herein. The processor 1500 may be configured to or operable to support at least one controller (e.g., the controller 1502) coupled with at least one memory (e.g., the memory 1504) and configured to cause the processor 1500 to receive, from an RTP device, one or more PDU sets, where each PDU set of the one or more PDU sets has a respective PDU set size and includes a respective PDU set size indication; and transmit, to the RTP device and in response to an inaccuracy condition being satisfied, a correction factor for one or more PDU set size indications, where the correction factor is based on a comparison between the respective PDU set size and the respective PDU set size indication.

Additionally, the processor 1500 may be configured to or operable to support any one or combination of the at least one controller is further configured to cause the processor 1500 to transmit the correction factor in an RTCP feedback message. The correction factor comprises an FCI field, and the RTCP feedback message comprises one of an RTCP-RTPFB or an RTCP-PSFB packet. The correction factor comprises a report block field, and the RTCP feedback message comprises an RTCP-XR packet. The at least one controller is further configured to cause the processor 1500 to communicate, as part of an SDP offer-answer procedure with the RTP device, a configuration for the RTCP feedback message. The configuration indicates at least one of a correction factor threshold associated with the inaccuracy condition, a threshold quantity of RTCP feedback message transmissions, or a threshold time interval between consecutive RTCP feedback message transmissions. The correction factor comprises a floating-point numeral. To determine the correction factor, the at least one controller is further configured to cause the processor 1500 to obtain, based on the comparison, a ratio of the respective PDU set sizes and the respective PDU set size indications, where the inaccuracy condition is satisfied based on the ratio satisfying a threshold. The RTP device comprises an RTP sender device and the processor 1500 comprises an RTP receiver device.

The processor 1500 may be configured to or operable to support at least one controller (e.g., the controller 1502) coupled with at least one memory (e.g., the memory 1504) and configured to cause the processor 1500 to transmit, to an RTP device, a first one or more PDU sets, where each PDU set of the first one or more PDU sets has a respective PDU set size and includes a respective PDU set size indication; receive, from the RTP device, a correction factor for PDU set size indications based on the first one or more PDU sets; calculate, for each PDU set of a second one or more PDU sets, a respective corrected PDU set size using the correction factor; and transmit, to the RTP device, the second one or more PDU sets, where each PDU set of the second one or more PDU sets includes a respective corrected PDU set size indication based on the respective corrected PDU set sizes.

Additionally, the processor 1500 may be configured to or operable to support any one or combination of the at least one controller is further configured to cause the processor to receive the correction factor in an RTCP feedback message. The correction factor comprises an FCI field, and the RTCP feedback message comprises one of an RTCP-RTPFB or an RTCP-PSFB packet. The correction factor comprises a report block field, and the RTCP feedback message comprises an RTCP-XR packet. The at least one controller is further configured to cause the processor 1500 to communicate, as part of an SDP offer-answer procedure with the RTP device, a configuration for the RTCP feedback message. The configuration indicates at least one of a correction factor threshold associated with the inaccuracy condition, a threshold quantity of RTCP feedback message transmissions, or a threshold time interval between consecutive RTCP feedback message transmissions. The correction factor comprises a floating-point numeral. The at least one controller is further configured to cause the processor 1500 to receive a second correction factor for PDU set size indications based on the second one or more PDU sets; and calculate a second corrected PDU set size for a subsequent one or more PDU sets using the second correction factor. The RTP device comprises an RTP sender device and the processor 1500 comprises an RTP receiver device.

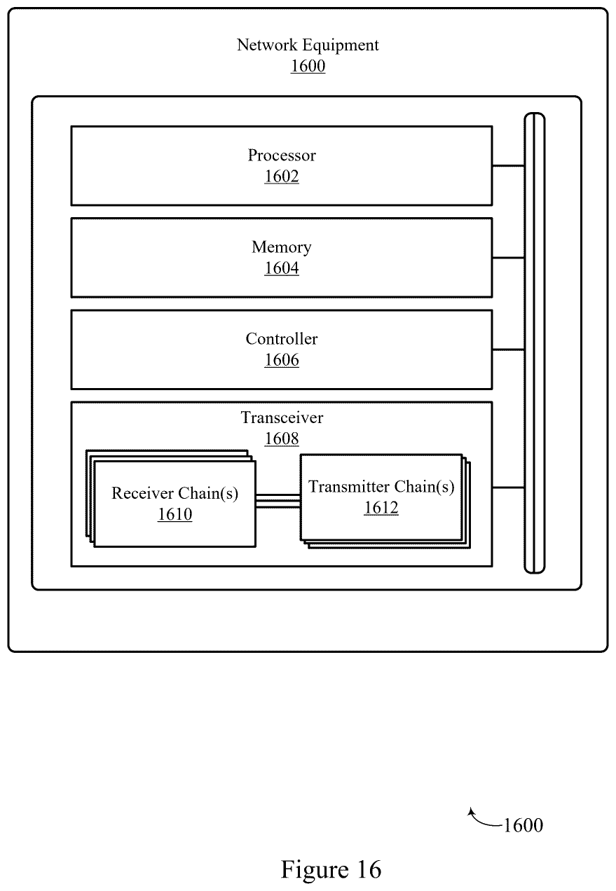

FIG. 16 illustrates an example of an NE 1600 in accordance with aspects of the present disclosure. The NE 1600 may include a processor 1602, a memory 1604, a controller 1606, and a transceiver 1608. The processor 1602, the memory 1604, the controller 1606, or the transceiver 1608, or various combinations thereof or various components thereof may be examples of means for performing various aspects of the present disclosure as described herein. These components may be coupled (e.g., operatively, communicatively, functionally, electronically, electrically) via one or more interfaces.

The processor 1602, the memory 1604, the controller 1606, or the transceiver 1608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1602 may include an intelligent hardware device (e.g., a general-purpose processor, a DSP, a CPU, an ASIC, an FPGA, or any combination thereof). In some implementations, the processor 1602 may be configured to operate the memory 1604. In some other implementations, the memory 1604 may be integrated into the processor 1602. The processor 1602 may be configured to execute computer-readable instructions stored in the memory 1604 to cause the NE 1600 to perform various functions of the present disclosure.

The memory 1604 may include volatile or non-volatile memory. The memory 1604 may store computer-readable, computer-executable code including instructions when executed by the processor 1602 cause the NE 1600 to perform various functions described herein. The code may be stored in a non-transitory computer-readable medium such as the memory 1604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1602 and the memory 1604 coupled with the processor 1602 may be configured to cause the NE 1600 to perform one or more of the functions described herein (e.g., executing, by the processor 1602, instructions stored in the memory 1604). For example, the processor 1602 may support wireless communication at the NE 1600 in accordance with examples as disclosed herein. The controller 1606 may manage input and output signals for the NE 1600. The controller 1606 may also manage peripherals not integrated into the NE 1600. In some implementations, the controller 1606 may utilize an operating system such as iOS®, ANDROID®, WINDOWS®, or other operating systems. In some implementations, the controller 1606 may be implemented as part of the processor 1602.

In some implementations, the NE 1600 may include at least one transceiver 1608. In some other implementations, the NE 1600 may have more than one transceiver 1608. The transceiver 1608 may represent a wireless transceiver. The transceiver 1608 may include one or more receiver chains 1610, one or more transmitter chains 1612, or a combination thereof.

A receiver chain 1610 may be configured to receive signals (e.g., control information, data, packets) over a wireless medium. For example, the receiver chain 1610 may include one or more antennas to receive a signal over the air or wireless medium. The receiver chain 1610 may include at least one amplifier (e.g., a low-noise amplifier (LNA)) configured to amplify the received signal. The receiver chain 1610 may include at least one demodulator configured to demodulate the receive signal and obtain the transmitted data by reversing the modulation technique applied during transmission of the signal. The receiver chain 1610 may include at least one decoder for decoding the demodulated signal to receive the transmitted data.

A transmitter chain 1612 may be configured to generate and transmit signals (e.g., control information, data, packets). The transmitter chain 1612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1612 may also include at least one power amplifier configured to amplify the modulated signal to an appropriate power level suitable for transmission over the wireless medium. The transmitter chain 1612 may also include one or more antennas for transmitting the amplified signal into the air or wireless medium.

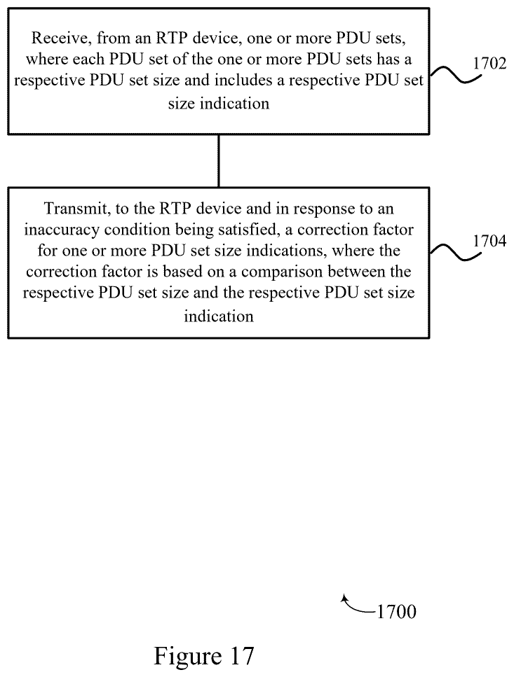

FIG. 17 illustrates a flowchart of a method 1700 in accordance with aspects of the present disclosure. The operations of the method may be implemented by an RTP receiver (e.g., a UE, an AS) as described herein. In some implementations, the RTP receiver may execute a set of instructions to control the function elements of the RTP receiver to perform the described functions. It should be noted that the method described herein describes a possible implementation, and that the operations and the steps may be rearranged or otherwise modified and that other implementations are possible.

At 1702, the method may include receiving, from an RTP device, one or more PDU sets, where each PDU set of the one or more PDU sets has a respective PDU set size and includes a respective PDU set size indication. The operations of 1702 may be performed in accordance with examples as described herein. In some implementations, aspects of the operations of 1702 may be performed by an apparatus as described with reference to FIG. 14.

At 1704, the method may include transmitting, to the RTP device and in response to an inaccuracy condition being satisfied, a correction factor for one or more PDU set size indications, where the correction factor is based on a comparison between the respective PDU set size and the respective PDU set size indication. The operations of 1704 may be performed in accordance with examples as described herein. In some implementations, aspects of the operations of 1704 may be performed by an apparatus as described with reference to FIG. 14.

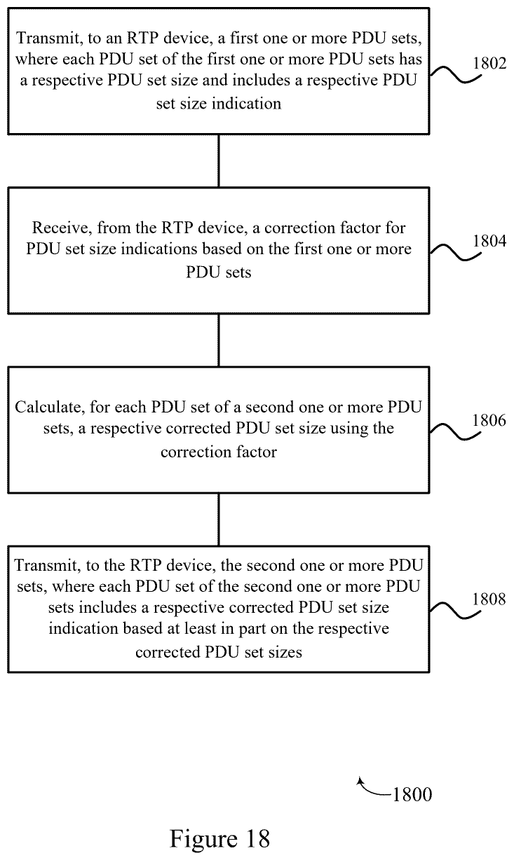

FIG. 18 illustrates a flowchart of a method 1800 in accordance with aspects of the present disclosure. The operations of the method may be implemented by an RTP sender as described herein. In some implementations, the RTP sender may execute a set of instructions to control the function elements of the RTP sender to perform the described functions. It should be noted that the method described herein describes a possible implementation, and that the operations and the steps may be rearranged or otherwise modified and that other implementations are possible.

At 1802, the method may include transmitting, to an RTP device, a first one or more PDU sets, where each PDU set of the first one or more PDU sets has a respective PDU set size and includes a respective PDU set size indication. The operations of 1802 may be performed in accordance with examples as described herein. In some implementations, aspects of the operations of 1802 may be performed by an apparatus as described with reference to FIG. 14, or alternatively by an apparatus as described with reference to FIG. 15.

At 1804, the method may include receiving, from the RTP device, a correction factor for PDU set size indications based on the first one or more PDU sets. The operations of 1804 may be performed in accordance with examples as described herein. In some implementations, aspects of the operations of 1804 may be performed by an apparatus as described with reference to FIG. 14, or alternatively by an apparatus as described with reference to FIG. 15.

At 1806, the method may include calculating, for each PDU set of a second one or more PDU sets, a respective corrected PDU set size using the correction factor. The operations of 1806 may be performed in accordance with examples as described herein. In some implementations, aspects of the operations of 1806 may be performed by an apparatus as described with reference to FIG. 14, or alternatively by an apparatus as described with reference to FIG. 15.

At 1808, the method may include transmitting, to the RTP device, the second one or more PDU sets, where each PDU set of the second one or more PDU sets includes a respective corrected PDU set size indication based at least in part on the respective corrected PDU set sizes. The operations of 1808 may be performed in accordance with examples as described herein. In some implementations, aspects of the operations of 1808 may be performed by an apparatus as described with reference to FIG. 14, or alternatively by an apparatus as described with reference to FIG. 15.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication, comprising:
at least one memory; and
at least one processor coupled with the at least one memory and configured to cause the apparatus to:
receive, from a real-time protocol (RTP) device, one or more protocol data unit (PDU) sets, wherein each PDU set of the one or more PDU sets has a respective PDU set size and includes a respective PDU set size indication; and
transmit, to the RTP device and in response to an inaccuracy condition being satisfied, a correction factor for one or more PDU set size indications, wherein the correction factor is based at least in part on a comparison between the respective PDU set size and the respective PDU set size indication.

2. The apparatus of claim 1, wherein, to transmit the correction factor, the at least one processor is further configured to cause the apparatus to transmit the correction factor in a real-time control protocol (RTCP) feedback message.

3. The apparatus of claim 2, wherein:
the correction factor comprises a feedback control information (FCI) field, and
the RTCP feedback message comprises one of an RTCP transport layer-level feedback message (RTCP-RTPFB) or an RTCP payload-specific feedback message (RTCP-PSFB) packet.

4. The apparatus of claim 2, wherein:
the correction factor comprises a report block field, and
the RTCP feedback message comprises an RTCP extended report (RTCP-XR) packet.

5. The apparatus of claim 2, wherein the at least one processor is further configured to cause the apparatus to:
communicate, as part of a session description protocol (SDP) offer-answer procedure with the RTP device, a configuration for the RTCP feedback message.

6. The apparatus of claim 5, wherein the configuration indicates at least one of a correction factor threshold associated with the inaccuracy condition, a threshold quantity of RTCP feedback message transmissions, or a threshold time interval between consecutive RTCP feedback message transmissions.

7. The apparatus of claim 1, wherein the correction factor comprises a floating-point numeral.

8. The apparatus of claim 1, wherein, to determine the correction factor, the at least one processor is further configured to cause the apparatus to:
obtain, based on the comparison, a ratio of the respective PDU set sizes and the respective PDU set size indications, wherein the inaccuracy condition is satisfied based at least in part on the ratio satisfying a threshold.

9. The apparatus of claim 1, wherein the RTP device comprises an RTP sender device and the apparatus comprises an RTP receiver device.

10. An apparatus for wireless communication, comprising:
at least one memory; and
at least one processor coupled with the at least one memory and configured to cause the apparatus to:
transmit, to a real-time protocol (RTP) device, a first one or more protocol data unit (PDU) sets, wherein each PDU set of the first one or more PDU sets has a respective PDU set size and includes a respective PDU set size indication;
receive, from the RTP device, a correction factor for PDU set size indications based at least in part on the first one or more PDU sets;
calculate, for each PDU set of a second one or more PDU sets, a respective corrected PDU set size using the correction factor; and
transmit, to the RTP device, the second one or more PDU sets, wherein each PDU set of the second one or more PDU sets includes a respective corrected PDU set size indication based at least in part on the respective corrected PDU set sizes.

11. The apparatus of claim 10, wherein the correction factor is received within a real-time control protocol (RTCP) feedback message.

12. The apparatus of claim 11, wherein:
the correction factor comprises a feedback control information (FCI) field, and
the RTCP feedback message comprises one of an RTCP transport layer-level feedback message (RTCP-RTPFB) or an RTCP payload-specific feedback message (RTCP-PSFB) packet.

13. The apparatus of claim 11, wherein:
the correction factor comprises a report block field, and
the RTCP feedback message comprises an RTCP extended report (RTCP-XR) packet.

14. The apparatus of claim 11, wherein the at least one processor is further configured to cause the apparatus to:
communicate, as part of a session description protocol (SDP) offer-answer procedure with the RTP device, a configuration for the RTCP feedback message.

15. The apparatus of claim 14, wherein the configuration indicates at least one of a correction factor threshold associated with an inaccuracy condition, a threshold quantity of RTCP feedback message transmissions, or a threshold time interval between consecutive RTCP feedback message transmissions.

16. The apparatus of claim 10, wherein the correction factor comprises a floating-point numeral.

17. The apparatus of claim 10, wherein the at least one processor is further configured to cause the apparatus to:
receive a second correction factor for PDU set size indications based at least in part on the second one or more PDU sets; and
calculate a second corrected PDU set size for a subsequent one or more PDU sets using the second correction factor.

18. The apparatus of claim 10, wherein the RTP device comprises an RTP receiver device and the apparatus comprises an RTP sender device.

19. A method for wireless communication, the method comprising:
receiving, from a real-time protocol (RTP) device, one or more protocol data unit (PDU) sets, wherein each PDU set of the one or more PDU sets has a respective PDU set size and includes a respective PDU set size indication;
determining a correction factor for PDU set size indications based at least in part on a comparison between the respective PDU set sizes and the respective PDU set size indications; and
transmitting, to the RTP device, the correction factor based at least in part on an inaccuracy condition being satisfied.

20. A method for wireless communication, the method comprising:
transmitting, to a real-time protocol (RTP) device, a first one or more protocol data unit (PDU) sets, wherein each PDU set of the first one or more PDU sets has a respective PDU set size and includes a respective PDU set size indication;
receiving, from the RTP device, a correction factor for PDU set size indications based at least in part on the first one or more PDU sets;
calculating, for each PDU set of a second one or more PDU sets, a respective corrected PDU set size using the correction factor; and
transmitting, to the RTP device, the second one or more PDU sets, wherein each PDU set of the second one or more PDU sets includes a respective corrected PDU set size indication based at least in part on the respective corrected PDU set sizes.
